(19) United States
(12) Patent Application Publication
(10) Pub. No.: US 2014/0272595 A1
(43) Pub. Date: Sep. 18, 2014

(54) COMPOSITIONS FOR USE AS PROTECTIVE LAYERS AND OTHER COMPONENTS IN ELECTROCHEMICAL CELLS

(71) Applicants: Sion Power Corporation, Tucson, AZ (US); BASF SE, Ludwigshafen (DE)

(72) Inventors: Anna Cristadoro, Waldems (DE); Oliver Gronwald, Heusenstamm (DE); Benedikt Crone, Mannheim (DE); Raimund Pietruschka, Ebertsheim (DE); Ingrid Haupt, Frankenthal (DE); Bala Sankaran, Tucson, AZ (US)

(73) Assignees: BASF SE, Ludwigshafen (DE); Sion Power Corporation, Tucson, AZ (US)

(21) Appl. No.: 14/203,802

(22) Filed: Mar. 11, 2014

Related U.S. Application Data
(60) Provisional application No. 61/812,121, filed on Apr. 15, 2013.
(60) Provisional application No. 61/792,315, filed on Mar. 15, 2013.

(51) Int. Cl. H01M 10/654

(52) U.S. Cl. CPC H01M 10/5042
USPC 429/231.95

(57) ABSTRACT

Electrode structures and electrochemical cells, including lithium-sulfur electrochemical cells, are provided. The electrode structures and/or electrochemical cells described herein may include one or more protective layers comprising a polymer layer and/or a gel polymer electrolyte layer. Methods for making electrode structures including such components are also provided.

### RELATED APPLICATIONS

The present application claims priority under 35 U.S.C. §119(e) to U.S. Provisional Patent Apl. No. 61/792,315, filed on Mar. 15, 2013, and entitled “Compositions For Use as Protective Layers and Other Components in Electrochemical Cells Comprising Lithium and Sulfur”, and U.S. Provisional Patent Apl. No. 61/812,121, filed on Apr. 15, 2013, and entitled “Compositions For Use as Protective Layers and Other Components in Electrochemical Cells”, each of which is hereby incorporated by reference in its entirety for all purposes.

### FIELD OF INVENTION

The present invention generally relates to polymer compositions for use as protective layers and other components in electrochemical cells (e.g., lithium-sulfur electrochemical cells). In some embodiments, electrode structures and/or methods for making electrode structures including an anode comprising lithium (e.g., metal or a lithium metal alloy) and a protective layer comprising the polymer composition are also provided.

### BACKGROUND

Lithium compound-containing electric cells and batteries containing such cells are modern means for storing energy. They exceed conventional secondary batteries with respect to capacity and life-time and, in many times, use of toxic materials such as lead can be avoided. However, in contrast to conventional lead-based secondary batteries, various technical problems have not yet been solved.

Secondary batteries based on cathodes comprising lithiated metal oxides such as LiCoO₂, LiMn₂O₄, and LiFePO₄ are established, see, e.g., EP 1 296 391 A1 and U.S. Pat. No. 6,962,666 and the patent literature cited therein. Although the batteries mentioned therein exhibit certain advantageous features, they are limited in capacity. For at least this reason, numerous attempts have been made to improve the electrode materials. Particularly promising are so-called lithium sulfur batteries. In such batteries, lithium will be oxidized and converted to lithium sulfides such as Li₂S₈₋ₐ, a being a number in the range from zero to 7. During recharging, lithium and sulfur will be regenerated. Such secondary cells have the advantage of a high capacity.

One example of a particular problem with lithium sulfur batteries is the thermal runaway which can be observed at elevated temperatures between, e.g., 150 to 230° C. and which leads to complete destruction of the battery. Various methods have been suggested to prevent thermal runaway such as the use of protective layers, including polymer coatings, for protecting the electrodes. However, those methods usually lead to a dramatic reduction in capacity. The loss in capacity has been ascribed—amongst others—to formation of lithium dendrites during recharging, loss of sulfur due to formation of soluble lithium sulfides such as Li₂S₃, Li₂S₄ or Li₂S₆, polysulfide shuttle, change of volume during charging or discharging and others. There are also other problems and challenges with lithium sulfur batteries.

Despite the various approaches proposed for forming electrodes and protective layers, and the various approaches for addressing thermal runaway and other problems associated with lithium batteries, improvements are needed.

### SUMMARY OF THE INVENTION

The present invention generally relates to polymer composition for use as protective layers and other components in electrochemical cells (e.g., electrochemical cells comprising lithium and sulfur). The subject matter of the present invention involves, in some cases, interrelated products, alternative solutions to a particular problem, and/or a plurality of different uses of one or more systems and/or articles.

In some embodiments, lithium-sulfur electrochemical cells are provided. In one set of embodiments, a lithium-sulfur electrochemical cell comprises an anode comprising lithium metal or a lithium metal alloy and a polymer layer comprising a polymeric material. The polymeric material comprises a branched polyimide formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol.

The electrochemical cell also includes a cathode comprising sulfur.

In another embodiment, a lithium-sulfur electrochemical cells comprises an anode comprising lithium metal or a lithium metal alloy and a polymer layer comprising a polymeric material. The polymer material has a decomposition temperature of greater than or equal to about 200° C. The electrochemical cell also includes a cathode comprising sulfur. The electrochemical cell is adapted and arranged to be operated at a temperature of greater than or equal to about 150° C. without employing an auxiliary cooling mechanism and without the electrochemical cell experiencing thermal runaway.

In one set of embodiments, a lithium-sulfur electrochemical cell comprises an anode comprising lithium metal or a lithium metal alloy, and a polymer layer comprising a polymeric material. The polymeric material comprises a branched polyimide formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol; and a cathode comprising sulfur.

In one set of embodiments, an electrochemical cell is provided, wherein the polymer layer is formed from at least one reaction product of (a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof, and

(b) at least one diol or triol, said reaction product being subsequently reacted with (c) at least one polyisocyanate having on average at least two isocyanate groups per molecule.

In one set of embodiments, an electrode structure is provided. The electrode structure comprises at least one electrode and a protective layer adjacent the electrode, wherein the protective layer comprises a polymeric material, and wherein the polymeric material comprises a branched polyimide formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol.

In one set of embodiments, a series of methods are provided. In one embodiments, a method comprises exposing an electrode to a solution comprising a branched polyimide formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol; and forming a protective layer adjacent the electrode, the protective layer comprising a polymer formed by crosslinking the branched polyimide with (c) at least one polyisocyanate having on average at least two isocyanate groups per molecule.

In one embodiment, a method comprises providing an electrode and forming a protective layer adjacent the electrode, wherein forming the protective layer comprises crosslinking a branched polyimide formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol, with (c) at least one polyisocyanate having on average at least two isocyanate groups per molecule.

In some embodiments, in a method described above and herein, the electrode comprises an anode comprising lithium metal or a lithium metal alloy, and/or the electrode comprises a cathode, optionally comprising sulfur.

In some embodiments, an electrochemical cell comprises an electrode associated with a polymer layer formed by a method described above and herein, or an electrode structure described above and herein.

In one set of embodiments, use of a polymeric material as polymer layer in an electrode, in an electrolyte, in a separator, in an article for use in an electrochemical cell, or in an electrochemical cell is provided. The polymeric material comprises a branched polyimide formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol.

In one embodiment, the use according to an embodiment described above and herein is provided, wherein the electrochemical cell is a lithium-sulfur electrochemical cell; the polymer layer is a protective layer; the electrolyte is a polymer gel electrolyte; and/or the electrode is an anode or a cathode.

In some of the electrochemical cells, electrode structures, uses, and methods provided above and herein, the at least one polyisocyanate (α) has on average between 2 and about 2.5 isocyanate groups per molecule. In some of the electrochemical cells, electrode structures, methods, and uses provided above and herein, the at least one polyisocyanate (α) has on average 2 isocyanate groups per molecule.

In some of the electrochemical cells, electrode structures, methods, and uses provided above and herein, the at least one polycarboxylic acid (β) has on average 3 COOH or on average 4 COOH groups per molecule or an anhydride or ester thereof. In some of the electrochemical cells, electrode structures, methods, and uses provided above and herein, the at least one polycarboxylic acid (β) has at least 4 COOH groups per molecule or an anhydride or ester thereof. In some of the electrochemical cells, electrode structures, methods, and uses provided above and herein, the at least one polycarboxylic acid (β) has at least 3 or at least 4 anhydride groups. In some of the electrochemical cells, electrode structures, methods, and uses provided above and herein, as polycarboxylic acid (β), a polycarboxylic acid having at least 4 COOH groups per molecule, or the respective anhydride or ester, is selected.

In some of the electrochemical cells, electrode structures, methods, and uses provided above and herein, the at least one polyisocyanate (c) has on average 2 isocyanate groups per molecule. In some of the electrochemical cells, electrode structures, methods, and uses provided above and herein, the at least one polyisocyanate (c) has on average greater than 2 isocyanate groups per molecule. In some of the electrochemical cells, electrode structures, methods, and uses provided above and herein, the at least one polyisocyanate (c) has on average between greater than 2 and about 4, or between 2.5 and 4 isocyanate groups per molecule.

In some of the electrochemical cells, electrode structures, methods, and uses provided above and herein, the reaction product is branched but not crosslinked.

In some of the electrochemical cells, electrode structures, methods, and uses provided above and herein, the reaction product is branched and crosslinked.

In some of the electrochemical cells, electrode structures, methods, and uses provided above and herein, following said subsequently reaction of the reaction product with (c) at least one polyisocyanate having on average at least two isocyanate groups per molecule, said branched polyimide is crosslinked.

In some of the electrochemical cells, electrode structures, methods, and uses provided above and herein, the polymer layer is incorporated into a separator, preferably the separator is located between the anode and the cathode of the electrochemical cell, more preferably the separator is adjacent to the anode and/or the cathode of the electrochemical cell.

In some of the electrochemical cells, electrode structures, methods, and uses provided above and herein, polyisocyanate (α) is selected from oligomeric hexamethylene diisocyanate, oligomeric tetramethylene diisocyanate, oligomeric isophorone diisocyanate, oligomeric diphenylmethane diisocyanate, oligomeric toluylene diisocyanate and mixtures of the above mentioned polyisocyanates.

In some of the electrochemical cells, electrode structures, methods, and uses provided above and herein, the polymer layer has a thickness in the range of from about 1 to about 20 μm. In some of the electrochemical cells, electrode structures, methods, and uses provided above and herein, the polymer layer has a thickness in the range of from about 1 to about 10 μm. In some of the electrochemical cells, electrode structures, methods, and uses provided above and herein, the polymer layer has a thickness about 1 μm.

In some of the electrochemical cells, electrode structures, methods, and uses provided above and herein, polyimide (a) has a polydispersity M_{w}/Mₙ of at least 1.4. In some of the electrochemical cells, electrode structures, methods, and uses provided above and herein, polyimide (a) has a polydispersity M_{w}/Mₙ of between about 2 and about 4.

In some of the electrochemical cells, electrode structures, methods, and uses provided above and herein, the polymer layer is adjacent the anode. Optionally, the polymer layer is directly adjacent the anode. In some of the electrochemical cells, electrode structures, methods, and uses provided above and herein, the polymer layer is adjacent the cathode. Optionally, the polymer layer is directly adjacent the cathode.

In some of the electrochemical cells, electrode structures, methods, and uses provided above and herein, the polymer layer functions as a protective layer for the cathode.

In some of the electrochemical cells, electrode structures, methods, and uses provided above and herein, the electrochemical cell comprises at least one protective layer adjacent the anode, and the polymer layer is positioned between the protective layer and the cathode.

In some of the electrochemical cells, electrode structures, methods, and uses provided above and herein, the cathode includes sulfur as a cathode active species. In some of the electrochemical cells, electrode structures, methods, and uses provided above and herein, the cathode includes elemental sulfur as a cathode active species.

In some of the electrochemical cells, electrode structures, methods, and uses provided above and herein, the electrochemical cell comprises at least one lithium salt. In some of the electrochemical cells, electrode structures, methods, and uses provided above and herein, the lithium salt is selected from LiNO₃, LiPF₆, LiBF₄, LiClO₄, LiAsF₆, Li₂SiF₆, LiSbF₆, LiAlCl₄, lithium bis-oxalatoborate, LiCF₃SO₃, LiN(SO₂F)₂, LiC(CₙF₂ₙ₊₁SO₂)₃, wherein n is an integer in the range of from 1 to 20, and salts of the general formula (CₙF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicon.

In some of the electrochemical cells, electrode structures, methods, and uses provided above and herein, the ionic conductivity of the polymer layer is at least about 1×10⁻⁴ S/cm at room temperature in a swollen state. In some of the electrochemical cells, electrode structures, methods, and uses provided above and herein, the polymer layer is stable to an applied pressure of at least 10 kg/cm² in a swollen state. In some of the electrochemical cells, electrode structures, methods, and uses provided above and herein, the ionic conductivity and/or stability is determined in 8 wt % lithium bis trifluoromethanesulfonimide and 4 wt % LiNO₂ in a 1:1 mixture by weight of 1,2-dimethoxyethane and 1,3-dioxolane.

In some of the electrochemical cells, electrode structures, methods, and uses provided above and herein, the polymer layer is a gel polymer layer.

In some of the electrochemical cells, electrode structures, methods, and uses provided above and herein, the polymer material is swellable in 1,2-dimethoxyethane and/or 1,3-dioxolane solvents.

In some of the electrochemical cells, electrode structures, methods, and uses provided above and herein, the electrochemical cell comprises the solvents 1,2-dimethoxyethane and/or 1,3-dioxolane.

In some of the electrochemical cells, electrode structures, methods, and uses provided above and herein, diol (b) is a polyalkyleneoxide. In some of the electrochemical cells, electrode structures, methods, and uses provided above and herein, diol (b) is polyethylene oxide, polypropylene oxide, polybutylene oxide, or polytetrahydrofuran (poly-THF), or copolymers thereof.

In some of the electrochemical cells, electrode structures, methods, and uses provided above and herein, the branched polyimide has a decomposition temperature of greater than or equal to about 200° C.

In some of the electrochemical cells, electrode structures, methods, and uses provided above and herein, the electrochemical cell is constructed and arranged to operate at a temperature of greater than or equal to about 150° C. without employing an auxiliary cooling mechanism and without the electrochemical cell experiencing thermal runaway.

In some embodiments, use of an electrochemical cell as described above or herein is provided for making or operating cars, computers, personal digital assistants, mobile telephones, watches, camcorders, digital cameras, thermometers, calculators, laptop BIOS, communication equipment or remote car locks.

The current disclosure should be viewed generally as disclosing the use of the currently disclosed polymers with an electrochemical cell, and should not be limited to only the specific constructions disclosed herein.

Other aspects, embodiments, and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows an article for use in an electrochemical cell according to one set of embodiments;

FIG. 2A shows an electrode including an electroactive layer and a multilayer protective structure according to one set of embodiments;

FIG. 2B shows an electrode including an electroactive layer and a polymer layer according to one set of embodiments; and

FIG. 3 shows an electrochemical cell according to one set of embodiments.

### DETAILED DESCRIPTION

Polymer compositions, and more specifically, polymer compositions for use in electrochemical cells, are provided. In some embodiments, the polymer composition comprises a polyimide, e.g., a branched polyimide. In some embodiments, the disclosed polymer compositions may be incorporated into an electrochemical cell (e.g., a lithium-sulfur electrochemical cell) as, for example, a protective layer for an electrode, a polymer gel electrolyte, a separator, and/or any other appropriate component within the electrochemical cell. In certain embodiments, electrode structures and/or methods for making electrode structures including an anode comprising lithium metal or a lithium metal alloy and a protective layer comprising a disclosed polymer composition are provided.

The disclosed polymer compositions may be incorporated into electrochemical cells, for example, primary batteries or secondary batteries, which can be charged and discharged numerous times. In some embodiments, the materials, systems, and methods described herein can be used in association with lithium batteries (e.g., lithium-sulfur batteries). The electrochemical cells described herein may be employed in various applications, for example, making or operating cars, computers, personal digital assistants, mobile telephones, watches, camcorders, digital cameras, thermometers, calculators, laptop BIOS, communication equipment or remote car locks.

In some embodiments, the polymers disclosed herein may be employed in electrode structures. For example, the electrode structures may include an electroactive layer (e.g., an anode or a cathode) and one or more polymer layers, optionally, present in a multi-layered structure. The multi-layered structure may include one or more ion conductive layers (e.g., a ceramic layer, a glassy layer, or a glassy-ceramic layer) and one or more polymer layers comprising the polymers disclosed herein disposed adjacent to the one or more ion conductive layers. The resulting structures may be highly conductive to electroactive material ions and may protect the underlying electroactive material surface from reaction with components in the electrolyte. In another set of embodiments, an electrochemical cell may include a gel polymer electrolyte layer comprising the disclosed polymer compositions. In some cases, such protective layers and/or gel polymer layers may be suitable for use in an electrochemical cell including an electroactive material comprising lithium (e.g., metallic lithium). In some embodiments, the polymer layer may be adjacent the anode. In some embodiments, the polymer layer may be adjacent the cathode. In some embodiments, an electrochemical cell comprises at least one protective layer adjacent the anode, and the polymer layer is positioned between the protective layer and the cathode.

In some embodiments, an electrochemical cell comprises a polymer composition comprising a branched polyimide. In some embodiments, the branched polyimide is a reaction product of

(a) at least one polyimide selected from condensation products of
(α) at least one polyisocyanate having on average at least two isocyanate groups per molecule, and
(β) at least one polycarboxylic acid having at least 3 COOH groups per molecule or an anhydride or ester thereof, and

(b) at least one compound including multiple hydroxyl groups (e.g., a diol or triol). Said polyimide is briefly referred to herein as polyimide (a). In some embodiments, the branched polyimide is branched but not crosslinked. In other embodiments, the branched polyimide is branched and crosslinked.

As noted above and as described in more detail herein, in some embodiments, an electrochemical cell comprising an anode comprising lithium metal or a lithium alloy, a polymer layer comprising a polymeric material, and a cathode comprising sulfur is provided, wherein said branched polyimide is formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol. The polymeric layer may function as a protective layer for the anode or cathode, as a polymer gel electrolyte, and/or as a separator. In one embodiment, the polymer layer is a protective layer for the anode or the cathode.

In certain embodiments, said branched polyimide formed by reaction of:

(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and

(b) at least one diol or triol, is used as a protective layer for an electrode (e.g., an anode (e.g., comprising lithium metal or a lithium alloy), and/or a cathode (e.g., comprising sulfur).

In some embodiments, the molecular weight M_{w} of polyimide (a) may be greater than or equal to about 1000 g/mol, greater than or equal to about 5000 g/mol, greater than or equal to about 10,000 g/mol, greater than or equal to about 15,000 g/mol, greater than or equal to about 20,000 g/mol, greater than or equal to about 50,000 g/mol, greater than or equal to about 100,000 g/mol, greater than or equal to about 200,000 g/mol. Further, the molecular weight of polyimide (a) may be less than or equal to about 200,000 g/mol, less than or equal to about 100,000 g/mol, less than or equal to about 50,000 g/mol, less than or equal to about 20,000 g/mol, less than or equal to about 15,000 g/mol, less than or equal to about 10,000 g/mol, or less than or equal to about 5000 g/mol. Combinations of the above are possible (e.g., a molecular weight of greater than or equal to about 1000 g/mol and less than or equal to about 200,000 g/mol, or greater than or equal to about 2000 g/mol and less than or equal to about 20,000 g/mol). Other combinations are also possible. Other ranges are also possible. In one particular set of embodiments, polyimide (a) has a molecular weight M_{w} of 1,000 to 200,000 g/mol or 2,000 to 20,000 g/mol. The molecular weight can be determined by known methods, in particular by gel permeation chromatography (GPC).

Polyimide (a) may include any suitable number of imide groups per molecule. In some embodiments, polyimide (a) comprises at least two imide groups per molecule. In certain embodiments, polyimide (a) comprises at least 3 imide groups per molecule. In certain instances, polyimide (a) includes at least 5, 10, 15, 20, 50, 100, 200, or 500 imide groups per molecule. In some embodiments, polyimide (a) may have up to 1,000 imide groups per molecule, or up to 660 imide groups per molecule. Stating the number of groups per molecule (e.g., imide groups, isocyanate groups, COOH groups per molecule) in each case denotes the mean value (number-average).

Polyimide (a) may be composed of structurally and molecularly uniform molecules. In some embodiments, polyimide (a) is a mixture of molecularly and structurally differing molecules, for example, visible from the polydispersity M_{w}/Mₙ of at least 1.4, at least 1.5, at least 2, at least 5, at least 10, at least 15, at least 20, at least 30, at least 40; and/or less than or equal to 50, less than or equal to 40, less than or equal to 30, less than or equal to 20, less than or equal to 10, less than or equal to 5, less than or equal to 4, or less than or equal to 3. Combinations of the above are possible (e.g., a polydispersity of at least 1.4 and less than or equal to 50, at least 1.5 and less than or equal to 10, or at least 2 and less than or equal to 4). In one particular set of embodiments, polyimide (a) has a polydispersity between 1.4 to 50, or between 1.5 to 10. The polydispersity can be determined by known methods, in particular by gel permeation chromatography (GPC). A suitable standard is, for example, poly(methyl methacrylate) (PMMA).

In some embodiments, polyimide (a), in addition to imide groups which form the polymer backbone, comprises, terminally or in side chains, at least 3, or at least 6, or at least 10, at least 20, at least 50, at least 100, or at least 200 terminal or side-chain functional groups. Functional groups in polyimide (a) may include, for example, anhydride or acid groups and/or free or capped NCO groups. In some embodiments, the functional groups do not include alkyl groups such as, for example, methyl groups. In some embodiments, polyimide (a) may have no more than 500, no more than 200, no more than 100, no more than 50, or no more than 10 terminal or side-chain functional groups. Combinations of the above are possible (e.g., at least 2 and no more than 100 functional groups). Other ranges are also possible.

In some embodiments, polyisocyanate (α) can be selected from polyisocyanates that have on average at least 2 (e.g., at least 3, at least 4, at least 5) isocyanate groups per molecule which can be present capped, or may be free. Non-limiting examples of polyisocyanates (α) are diisocyanates, for example, hexamethylene diisocyanate, isophorone diisocyanate, toluylene diisocyanate, 4,4′-diphenylmethane diisocyanate, 2,4′-diphenylmethane diisocyanate, or mixtures of at least two of the above mentioned polyisocyanates (α). Non-limiting examples of mixtures include mixtures of 4,4′-diphenylmethane diisocyanate and 2,4′-diphenylmethane diisocyanate and mixtures of 2,4-toluylene diisocyanate and 2,6-toluylene diisocyanate.

In some embodiments, polyisocyanate (α) is selected from oligomeric hexamethylene diisocyanate, oligomeric tetramethylene diisocyanate, oligomeric isophorone diisocyanate, oligomeric diphenylmethane diisocyanate, oligomeric toluylene diisocyanate, or mixtures of at least two of the above mentioned polyisocyanates (α). For example, what is termed trimeric hexamethylene diisocyanate is in many cases not the pure trimeric diisocyanate, but the polyisocyanate having a mean functionality of 3.6 to 4 NCO groups per molecule. The same applies to oligomeric tetramethylene diisocyanate and oligomeric isophorone diisocyanate.

In some embodiments, polyisocyanate (α) is a mixture of at least one diisocyanate and at least one triisocyanate or a polyisocyanate having at least 4 isocyanate groups per molecule. In some embodiments, polyisocyanate (α) has on average exactly 2.0 isocyanate groups per molecule. In other embodiments, polyisocyanate (α) has on average at least 2.2, or at least 2.5, or at least 3.0 isocyanate groups per molecule. In some embodiments, polyisocyanate (α) has, on average, between 2 and about 2.5 isocyanate groups per molecule. In some embodiments, polyisocyanate (α) has, on average, 2 isocyanate groups per molecule. In some embodiments, polyisocyanate (α) has on average up to 8, or up to 6, isocyanate groups per molecule. In some embodiments, polyisocyanate (α) is selected from oligomeric hexamethylene diisocyanate, oligomeric isophorone diisocyanate, oligomeric diphenylmethane diisocyanate, or mixtures of the above mentioned polyisocyanates.

In some embodiments, polyisocyanate (α), in addition to urethane groups, can also have one or more other functional groups, for example urea, allophanate, biuret, carbodiimide, amide, ester, ether, uretonimine, uretdione, isocyanurate, or oxazolidine functional groups.

In some embodiments, as polycarboxylic acids (β), aliphatic or aromatic polycarboxylic acids may be selected that have at least 3 (e.g., at least 4, at least 5, at least 6) COOH groups per molecule, or the respective anhydride or ester thereof. The aliphatic or aromatic polycarboxylic acids may be in a low-molecular weight form, that is to say the non-polymer form. In some embodiments, the polycarboxylic acids having at least 3, 4, 5, 6 COOH groups include at least one carboxylic acid group (e.g., 2 carboxylic acid groups) that are present as anhydride and at least one free carboxylic acid. For example, those polycarboxylic acids having 3 COOH groups in which two carboxylic acid groups are present as anhydride and the third as free carboxylic acid are also included. In some embodiments, as polycarboxylic acid (β), a polycarboxylic acid having at least 4 COOH groups per molecule is selected, or the respective anhydride. In some embodiments, a polycarboxylic acid (β) has on average 3 COOH or on average 4 COOH groups per molecule or the respective anhydride or ester thereof. In some embodiments, polycarboxylic acids (β) has at least 4 COOH groups per molecule or an anhydride or ester thereof. In some embodiments, a polycarboxylic acid (β) has at least 3 or at least 4 anhydride groups.

Non-limiting examples of polycarboxylic acids (β) and anhydrides thereof are 1,2,3-benzenetricarboxylic acid and 1,2,3-benzenetricarboxylic monoanhydride, 1,3,5-benzenetricarboxylic acid (trimesic acid), 1,2,4-benzenetricarboxylic acid (trimellitic acid), trimellitic anhydride, or 1,2,4,5-benzenetetracarboxylic acid (pyromellitic acid) and 1,2,4,5-benzenetetracarboxylic dianhydride (pyromellitic dianhydride), 3,3′,4,4′-benzophenonetetracarboxylic acid, 3,3′,4,4′-benzophenonetetracarboxylic dianhydride, in addition benzenehexacarboxylic acid (mellitic acid) and anhydrides of mellitic acid.

Other non-limiting examples of polycarboxylic acids and anhydrides thereof include mellophanic acid and mellophanic anhydride, 1,2,3,4-benzenetetracarboxylic acid and 1,2,3,4-benzenetetracarboxylic dianhydride, 3,3,4,4-biphenyltetracarboxylic acid and 3,3,4,4-biphenyltetracarboxylic dianhydride, 2,2,3,3-biphenyltetracarboxylic acid and 2,2,3,3-biphenyltetracarboxylic dianhydride, 1,4,5,8-naphthalenetetracarboxylic acid and 1,4,5,8-naphthalenetetracarboxylic dianhydride, 1,2,4,5-naphthalenetetracarboxylic acid and 1,2,4,5-naphthalenetetracarboxylic dianhydride, 2,3,6,7-naphthalenetetracarboxylic acid and 2,3,6,7-naphthalenetetracarboxylic dianhydride, 1,4,5,8-decahydronaphthalenetetracarboxylic acid and 1,4,5,8-decahydronaphthalenetetracarboxylic dianhydride, 4,8-dimethyl-1,2,3,5,6,7-hexahydronaphthalene-1,2,5,6-tetracarboxylic acid and 4,8-dimethyl-1,2,3,5,6,7-hexahydronaphthalene-1,2,5,6-tetracarboxylic dianhydride, 2,6-dichloronaphthalene-1,4,5,8-tetracarboxylic acid and 2,6-dichloronaphthalene-1,4,5,8-tetracarboxylic dianhydride, 2,7-dichloronaphthalene-1,4,5,8-tetracarboxylic acid and 2,7-dichloronaphthalene-1,4,5,8-tetracarboxylic dianhydride, 2,3,6,7-tetrachloronaphthalene-1,4,5,8-tetracarboxylic acid and 2,3,6,7-tetrachloronaphthalene-1,4,5,8-tetracarboxylic dianhydride, 1,3,9,10-phenanthrenetetracarboxylic acid and 1,3,9,10-phenanthrenetetracarboxylic dianhydride, 3,4,9,10-perylenetetracarboxylic acid and 3,4,9,10-perylenetetracarboxylic dianhydride, bis(2,3-dicarboxyphenyl)methane and bis(2,3-dicarboxyphenyl)methane dianhydride, bis(3,4-dicarboxyphenyl)methane and bis(3,4-dicarboxyphenyl)methane dianhydride, 1,1-bis(2,3-dicarboxyphenyl)ethane and 1,1-bis(2,3-dicarboxyphenyl)ethane dianhydride, 1,1-bis(3,4-dicarboxyphenyl)ethane and 1,1-bis(3,4-dicarboxyphenyl)ethane dianhydride, 2,2-bis(2,3-dicarboxyphenyl)propane and 2,2-bis(2,3-dicarboxyphenyl)propane dianhydride, 2,3-bis(3,4-dicarboxyphenyl)propane and 2,3-bis(3,4-dicarboxyphenyl)propane dianhydride, bis(3,4-carboxyphenyl)sulfone and bis(3,4-carboxyphenyl)sulfone dianhydride, bis(3,4-carboxyphenyl)ether and bis(3,4-carboxyphenyl)ether dianhydride, ethylenetetracarboxylic acid and ethylenetetracarboxylic dianhydride, 1,2,3,4-butanetetracarboxylic acid and 1,2,3,4-butanetetracarboxylic dianhydride, 1,2,3,4-cyclopentanetetracarboxylic acid and 1,2,3,4-cyclopentanetetracarboxylic dianhydride, 2,3,4,5-pyrrolidinetetracarboxylic acid and 2,3,4,5-pyrrolidinetetracarboxylic dianhydride, 2,3,5,6-pyrazinetetracarboxylic acid and 2,3,5,6-pyrazinetetracarboxylic dianhydride, 2,3,4,5-thiophenetetracarboxylic acid and 2,3,4,5-thiophenetetracarboxylic dianhydride.

In some embodiments, anhydrides from U.S. Pat. No. 2,155,687 or U.S. Pat. No. 3,277,117, which are incorporated herein by reference, are used for the synthesis of polyimide (a).

If polyisocyanate (α) and polycarboxylic acid (β) are condensed with one another (e.g., in the presence of a catalyst) then an imide group is formed with elimination of CO₂ and H₂O. If, instead of polycarboxylic acid (β), the corresponding anhydride is used, then an imide group is formed with elimination of CO₂.

[chemical structure]

In the above reaction equations, R* is the radical of polyisocyanate (α), and n is a number greater than or equal to 1, for example, 1 in the case of a tricarboxylic acid or 2 in the case of a tetracarboxylic acid, wherein (HOOC)ₙ can be replaced by an anhydride group of the formula C(═O)—O—C(═O).

In some embodiments, polyisocyanate (α) is used in a mixture with at least one diisocyanate, for example with toluylene diisocyanate, hexamethylene diisocyanate or with isophorone diisocyanate. In a particular embodiment, polyisocyanate (α) is used in a mixture with the corresponding diisocyanate, for example, trimeric hyperbranched diisocyanate with hexamethylene diisocyanate, or trimeric isophorone diisocyanate with isophorone diisocyanate, or polymeric diphenylmethane diisocyanate (“polymer MDI”) with diphenylmethane diisocyanate.

In some embodiments, polycarboxylic acid (β) is used in a mixture with at least one dicarboxylic acid or with at least one dicarboxylic anhydride, for example with phthalic acid or phthalic anhydride.

The at least one compound including multiple hydroxyl groups (b), e.g., a diol (b) or triol (b), can have a low-molecular-weight or a high-molecular-weight. Non-limiting examples of triols (b) are glycerol and 1,1,1-(trihydroxymethylene)methane, 1,1,1-(trihydroxymethylene)ethane and 1,1,1-(trihydroxymethylene)propane. In some embodiments, a diol (b) is employed. In one set of embodiments, a diol (b) is used.

In some embodiments, low-molecular-weight diols (b) are employed, wherein the molecular weight of the diol (b) is less than 500 g/mol. Non-limiting examples of such diols include 1,2-ethanediol, 1,2-propanediol, 1,3-propanediol, 1,2-butanediol, 1,3-butanediol, 1,4-butanediol, 1,4-but-2-enediol, 1,4-but-2-ynediol, 1,5-pentanediol and positional isomers thereof, 1,6-hexanediol, 1,8-octanediol, 1,4-bishydroxymethylcyclohexane, 2,2-bis-(4-hydroxycyclohexyl)propane, 2-methyl-1,3-propanediol, diethylene glycol, triethylene glycol, tetraethylene glycol, and 2,2-dimethylpropane-1,3-diol (neopentyl glycol).

In some embodiments, the at least one compound including multiple hydroxyl groups (b) is a polymeric diol. In some embodiments, as polymeric diols, dihydric or polyhydric polyester polyols and polyether polyols may be employed, for example, dihydric diols. As polyether polyols, polyether diols come into consideration and are obtainable, for example, by boron trifluoride-catalyzed linking of ethylene oxide, propylene oxide, butylene oxide, tetrahydrofuran, styrene oxide or epichlorohydrin with itself or among one another or by addition of these compounds, individually or in a mixture, to starter components having reactive hydrogen atoms such as water, polyhydric alcohols, or amines such as 1,2-ethanediol, propane-(1,3)-diol, 1,2- or 2,2-bis-(4-hydroxyphenyl)propane or aniline. In addition, polyether-1,3-diols, for example trimethylol propane alkoxylated at an —OH group, the alkylene oxide chain of which is closed with an alkyl radical comprising 1 to 18 carbon atoms, may be employed as polymeric diols. In one particular set of embodiments, polymeric diol (b) may include polyethylene glycol, polypropylene glycol and/or polytetrahydrofuran (poly-THF).

In some embodiments, the diol (b) is a polyalkyleneoxide, for example, a C₁-C₄ polyalkyleneoxide. In some embodiments, diol (b) is polyethylene oxide, polypropylene oxide, polybutylene oxide, or polytetrahydrofuran (poly-THF), or copolymers thereof. In some embodiments, diol (b) is polyethylene glycol, polypropylene glycol, or polytetrahydrofuran (poly-THF). Non-limiting examples of polyether polyols include polyethylene glycol (e.g., having an average molecular weight (Mₙ) in the range from 200 to 9000 g/mol, or from 500 to 6000 g/mol), poly-1,2-propylene glycol or poly-1,3-propane diol (e.g., having an average molecular weight (Mₙ) in the range from 250 to 6000, or from 600 to 4000 g/mol), or poly-THF (e.g., having an average molecular weight (Mₙ) in the range from above 250 to 5000, or from 500 to 3000 g/mol or from 50 to 2500 g/mol).

In some embodiments, the polymeric diol is a polyester polyol (polyester diol) or a polycarbonate diol. As polycarbonate diols, in particular aliphatic polycarbonate diols may be included, for example 1,4-butanediol polycarbonate and 1,6-hexanediol polycarbonate. As polyester diols, those which may be included are those which may be produced by polycondensation of at least one primary diol, for example, at least one primary aliphatic diol (e.g., ethylene glycol, 1,4-butanediol, 1,6-hexanediol, neopentyl glycol, 1,4-dihydroxymethylcyclohexane (e.g., as mixture of isomers), or mixtures of at least two of the above mentioned diols). In some embodiments, at least one, (e.g., at least two dicarboxylic acids or anhydrides thereof) may be employed. Non-limiting examples of dicarboxylic acids included aliphatic dicarboxylic acids such as adipic acid, glutaric acid, succinic acid and aromatic dicarboxylic acids such as, for example, phthalic acid and isophthalic acid.

In some embodiments, polyester diols and polycarbonate diols are selected from those having an average molecular weight (Mₙ) in the range from 500 to 9000 g/mol, or from 500 to 6000 g/mol. In some embodiments, the diol is polytetrahydrofuran, for example having an average molecular weight Mₙ in the range from 250 to 2000 g/mol.

In some embodiments, a reaction product from polyimide (a) and diol (b) or triol (b) has an acid value in the range from zero to 300 mg of KOH/g, determined as specified in DIN 53402, or from zero to 200 mg of KOH/g. In some embodiments, reaction product from polyimide (a) and diol (b) or triol (b) has a hydroxyl number in the range from zero to 300 mg of KOH/g, determined as specified in DIN 53240-2, or from zero to 200 mg of KOH/g.

In some embodiments, the reaction product from polyimide (a) and diol (b) or triol (b) has a quotient M_{w}/Mₙ in the range from 1.2 to 10, or from 1.5 to 5, or from 1.8 to 4. In this case, M_{w} and Mₙ may be determined by gel-permeation chromatography.

In some embodiments, the molecular weight of the reaction product from polyimide (a) and diol (b) or triol (b) (e.g., M_{w}) may be greater than or equal to about 1000 g/mol, greater than or equal to about 5000 g/mol, greater than or equal to about 10,000 g/mol, greater than or equal to about 15,000 g/mol, greater than or equal to about 20,000 g/mol, greater than or equal to about 50,000 g/mol, greater than or equal to about 100,000 g/mol, greater than or equal to about 200,000 g/mol. Further, the molecular weight of the resulting polymer may be less than or equal to about 200,000 g/mol, less than or equal to about 100,000 g/mol, less than or equal to about 50,000 g/mol, less than or equal to about 20,000 g/mol, less than or equal to about 15,000 g/mol, less than or equal to about 10,000 g/mol, or less than or equal to about 5000 g/mol. Combinations of the above are possible (e.g., a molecular weight of greater than or equal to about 1000 g/mol and less than or equal to about 200,000 g/mol, or greater than or equal to about 2000 g/mol and less than or equal to about 20,000 g/mol). Other combinations are also possible. Other ranges are also possible.

Non-limiting examples of synthesis methods for making polyimides (a) are described below. In some embodiments, the synthesis method for making polyimides (a) comprises reacting with one another

(α) at least one polyisocyanate having on average at least two isocyanate groups per molecule and

(β) at least one polycarboxylic acid having at least 3 COOH groups per molecule or an anhydride or ester thereof, in the presence of a catalyst. As catalysts, in particular water and Brønsted bases may be suitable, for example alkali metal alcoholates, in particular alkanoates of sodium or potassium, for example sodium methanolate, sodium ethanolate, sodium phenolate, potassium methanolate, potassium ethanolate, potassium phenolate, lithium methanolate, lithium ethanolate and lithium phenolate.

For carrying out the synthesis method for making polyimides (a), polyisocyanate (α) and polycarboxylic acid (β) or anhydride (β) can be used in a quantitative ratio such that the molar fraction of NCO groups to COOH groups is in the range from 1:3 to 3:1, or from 1:2 to 2:1. In this case, one anhydride group of the formula CO—O—CO counts as two COOH groups.

In some embodiments, catalyst can be used in the range from 0.005 to 0.1% by weight, or from 0.01 to 0.05%, based on the sum of polyisocyanate (α) and polycarboxylic acid (β) or polyisocyanate (α) and anhydride (β).

In some embodiments, synthesis methods for making polyimides (a) can be carried out at temperatures in the range from 50 to 200° C., or from 50 to 140° C., or from 50 to 100° C.

In some embodiments, synthesis methods for making polyimides (a) can be carried out at atmospheric pressure. However, the synthesis is also possible under pressure, for example at pressures in the range from 1.1 to 10 bar.

In some embodiments, synthesis methods for making polyimides (a) may be carried out in the presence of a solvent or solvent mixture. Non-limiting examples of suitable solvents are N-methylpyrrolidone, N-ethylpyrrolidone, dimethylformamide, dimethylacetamide, dimethyl sulfoxide, dimethyl sulphones, xylene, phenol, cresol, cyclic ethers such as, for example, tetrahydrofurane or 1,4-dioxane, cyclic acetals such as 1,3-dioxolane or 1,3-dioxane, ketones such as, for example, acetone, methyl ethyl ketone (MEK), methyl isobutyl ketone (MIBK), acetophenone, in addition mono- and dichlorobenzene, ethylene glycol monoethyl ether acetate and mixtures of two or more of the above mentioned mixtures. In this case, the solvent or solvents may be present during the entire synthesis time or only during part of the synthesis. The reaction may be carried out, for example, for a time period of 10 minutes to 24 hours.

In some embodiments, synthesis methods for making polyimides (a) may be carried out under inert gas, for example under argon or under nitrogen. If water-sensitive Brønsted base is used as catalyst, the reaction may employ dry inert gas and solvent. If water is used as catalyst, the drying of solvent and inert gas is generally not required.

In a particular embodiment, (a), NCO end groups of polyimide (a) can be blocked with a blocking agent (d), for example with secondary amine (e.g., dimethylamine, di-n-butylamine, diethylamine).

In some embodiments, the reaction product of polyimide (a) with diol (b) or triol (b) can subsequently be reacted with

(c) one polyisocyanate having on average at least two isocyanate groups per molecule, briefly also referred to as polyisocyanate (c). In some embodiments, following reaction of the reaction product with (c) at least one polyisocyanate, the product may be crosslinked.

Polyisocyanate (c) can be selected from any polyisocyanates that have on average at least two isocyanate groups (e.g., at least 3, at least 4, at least 5) per molecule which can be present capped or free. Non-limiting examples of polyisocyanates (c) are diisocyanates, for example hexamethylene diisocyanate, isophorone diisocyanate, toluylene diisocyanate, 4,4′-diphenylmethane diisocyanate, 2,4′-diphenylmethane diisocyanate, or mixtures of at least two of the above mentioned polyisocyanates (α). Non-limiting examples of mixtures are mixtures of 4,4′-diphenylmethane diisocyanate and 2,4′-diphenylmethane diisocyanate and mixtures of 2,4-toluylene diisocyanate and 2,6-toluylene diisocyanate.

In some embodiments, polyisocyanate (c) is selected from oligomeric hexamethylene diisocyanate, oligomeric tetramethylene diisocyanate, oligomeric isophorone diisocyanate, oligomeric diphenylmethane diisocyanate, oligomeric toluylene diisocyanate (e.g., trimeric toluylene diisocyanate), or mixtures of at least two of the above mentioned polyisocyanates (c). For example, what is termed trimeric hexamethylene diisocyanate is in many cases not the pure trimeric diisocyanate, but the polyisocyanate having a mean functionality of 3.6 to 4 NCO groups per molecule. The same applies to oligomeric tetramethylene diisocyanate and oligomeric isophorone diisocyanate. In some embodiments, polyisocyanate (c) is a mixture of at least one diisocyanate and at least one triisocyanate or a polyisocyanate having at least 4 isocyanate groups per molecule. In some embodiments, polyisocyanate (c) has on average exactly 2.0 isocyanate groups per molecule. In some embodiments, polyisocyanate (c) has on average up to 8, or up to 6, isocyanate groups per molecule. In another embodiment of the present invention, polyisocyanate (c) has on average at least 2.2, or at least 2.5, or at least 3.0, isocyanate groups per molecule. In another embodiment, polyisocyanate (c) has on average 2 isocyanate groups per molecule. In another embodiment, polyisocyanate (c) has on average greater than 2 isocyanate groups per molecule. In another embodiment, polyisocyanate (c) has on average between greater than 2 and about 4, or between 2.5 and 4 isocyanate groups per molecule. Preference is given to at least 2.5, or particularly preferred is at least 3.0, isocyanate groups per molecule.

In some embodiments, polyisocyanate (c) is selected from oligomeric hexamethylene diisocyanate, oligomeric isophorone diisocyanate, oligomeric diphenylmethane diisocyanate, or mixtures of the above mentioned polyisocyanates.

Polyisocyanate (c), in addition to urethane groups, can also have one or more other functional groups, for example urea, allophanate, biuret, carbodiimide, amide, ester, ether, uretonimine, uretdione, isocyanurate, or oxazolidine functional groups.

In some embodiments, polyisocyanate (α) and polyisocyanate (c) of a specific polymer (D) are equal. In an alternative embodiment, polyisocyanate (α) and polyisocyanate (c) of a specific polymer (D) are different.

The reaction with polyisocyanate (c) can be carried out without or with a solvent, such as NMP, THF, 1,3-dioxolane or 1,4-dioxane. The reaction with polyisocyanate (c) can be carried out without or with a catalyst. In one set of embodiments, a catalyst is not used. The reaction with polyisocyanate (c) can be carried out at a temperature in the range of from 10 to 90° C., or 20 to 30° C. In some embodiments, the reaction with polyisocyanate (c) is carried out at normal pressure.

In yet another embodiment, the polymerization of the monomers described herein may result in a polymer that is more stable to hydrolysis and other reactions with polysulfides in lithium-sulfur batteries compared to certain existing polymers (e.g., polyacrylates).

Having generally described the types of polymers in the compositions described herein, the incorporation of the polymers into an electrochemical cell will now be described. While many embodiments described herein describe lithium/sulfur, it is to be understood that any analogous alkali metal/sulfur electrochemical cells (including alkali metal anodes) can be used. As noted above and as described in more detail herein, in some embodiments, the branched polyimide is incorporated into a lithium-sulfur electrochemical cell as a protective layer for an electrode, a polymer gel electrolyte, and/or a separator. In other embodiments, one or more of the polymeric materials disclosed herein serve as a protective layer for an anode comprising lithium.

As described herein, in some embodiments an article such as an electrode or electrochemical cell includes a protective layer and/or protective structure (e.g., a multi-layered structure) that incorporates one or more of the herein disclosed polymers to separate an electroactive material from an electrolyte to be used with the electrode or electrochemical cell. The separation of an electroactive layer from the electrolyte of an electrochemical cell can be desirable for a variety of reasons, including (e.g., for lithium batteries) the prevention of dendrite formation during recharging, preventing reaction of lithium with the electrolyte or components in the electrolyte (e.g., solvents, salts and cathode discharge products), increasing cycle life, and improving safety (e.g., preventing thermal runaway). Reaction of an electroactive lithium layer with the electrolyte may result in the formation of resistive film barriers on the anode, which can increase the internal resistance of the battery and lower the amount of current capable of being supplied by the battery at the rated voltage.

In some embodiments, a protective layer and/or protective structure that incorporates one or more of the polymers described herein is substantially impermeable to the electrolyte. In certain embodiments, the protective layer and/or protective structure is unswollen in the presence of the electrolyte. The protective layer and/or protective structure may, in some cases, be substantially non-porous. In certain embodiments, the protective layer and/or protective structure may have an average pore size of less than or equal to 10 microns, less than or equal to 5 microns, less than or equal to 2 microns, less than or equal to 1 micron, less than or equal to 0.5 microns, less than or equal to 0.1 microns, less than or equal to 50 nm, less than or equal to 20 nm, less than or equal to 10 nm, or less than or equal to 5 nm. Generally, the protective layer is formed associated with an electrode.

In others embodiments, one or more of the herein disclosed polymers may serve as a protective layer for the cathode. The polymer may, for example, compensate for the roughness of the cathode if the cathode is not smooth.

While a variety of techniques and components for protection of lithium and other alkali metal anodes are known, these protective coatings present particular challenges, especially in rechargeable batteries. Since lithium batteries function by removal and re-plating of lithium from a lithium anode in each discharge/charge cycle, lithium ions must be able to pass through any protective coating. The coating must also be able to withstand morphological changes as material is removed and re-plated at the anode. The effectiveness of the protective structure in protecting an electroactive layer may also depend, at least in part, on how well the protective structure is integrated with the electroactive layer, the presence of any defects in the structure, and/or the smoothness of the layer(s) of the protective structure. Many single thin film materials, when deposited on the surface of an electroactive lithium layer, do not have all of the necessary properties of passing Li ions, forcing a substantial amount of the Li surface to participate in current conduction, protecting the metallic Li anode against certain species (e.g., liquid electrolyte and/or polysulfides generated from a sulfur-based cathode) migrating from the cathode, and impeding high current density-induced surface damage.

The inventors of the present application have developed solutions to address the problems described herein through several embodiments of the invention, including, in one set of embodiments, the combination of an electroactive layer and a protective structure including a layer formed at least in part of a polymer described herein. In another set of embodiments, an electroactive layer may include a protective structure in combination with a polymer gel layer formed from one or more the polymers disclosed herein positioned adjacent the protective structure.

In another set of embodiments, solutions to the problems described herein involve the use of an article including an anode comprising lithium, or any other appropriate electroactive material, and a multi-layered structure positioned between the anode and an electrolyte of the cell. The multi-layered structure may serve as a protective layer or structure as described herein. In some embodiments, the multi-layered structure may include, for example, at least a first ion conductive material layer and at least a first polymeric layer formed from one or more of the polymers disclosed herein and positioned adjacent the ion conductive material. In this embodiment, the multi-layered structure can optionally include several sets of alternating ion conductive material layers and polymeric layers. The multi-layered structures can allow passage of lithium ions, while limiting passage of certain chemical species that may adversely affect the anode (e.g., species in the electrolyte). This arrangement can provide significant advantage, as polymers can be selected that impart flexibility to the system where it can be needed most, namely, at the surface of the electrode where morphological changes occur upon charge and discharge.

In some embodiments, ionic compounds (i.e., salts) may be included in the disclosed polymer compositions. For example, in some embodiments, lithium salts may be advantageously included in a polymer layer in relatively high amounts. Inclusion of the lithium and/or other salts may increase the ion conductivity of the polymer. Increases in the ion conductivity of the polymer may enable enhanced ion diffusion between associated anodes and cathodes within an electrochemical cell. Therefore, inclusion of the salts may enable increases in specific power available from an electrochemical cell and/or extend the useful life of an electrochemical cell due to the increased diffusion rate of the ion species there through.

In another embodiment, one or more of the polymers described herein may be deposited between the active surface of an electroactive material and an electrolyte to be used in the electrochemical cell. Other configurations of polymers and polymer layers are also provided herein.

In some embodiments, certain methods of synthesis are employed for forming a protective layer comprising a polymer composition described herein. The method may involve forming the protective layer adjacent or on a portion of an anode comprising lithium.

In one particular embodiment, a method involves providing an anode comprising lithium, and forming a protective layer comprising a polymer adjacent the anode. The step of forming the protective layer comprising the polymer may involve crosslinking a branched polyimide formed by reaction of: (a) at least one polyimide selected from condensation products of: (α) at least one polyisocyanate having on average at least two isocyanate groups per molecule; and (β) at least one polycarboxylic acid having at least 3 COOH groups per molecule or an anhydride or ester thereof; and (b) at least one diol or triol, with (c) at least one polyisocyanate having on average at least two isocyanate groups per molecule. As described herein, the protective layer comprising the polymer may be directly adjacent the anode, or an intervening layer (e.g., another protective layer) may be present between the anode and the protective layer comprising the polymer. In some embodiments, the protective layer comprising the polymer may be part of a multi-layered protective structure.

In another particular embodiment, a method comprises exposing an anode comprising lithium to a solution comprising a branched polyimide formed by reaction of (a) at least one polyimide selected from condensation products of: (α) at least one polyisocyanate having on average at least two isocyanate groups per molecule; and (β) at least one polycarboxylic acid having at least 3 COOH groups per molecule or an anhydride or ester thereof; and (b) at least one diol or triol. The protective layer comprising the polymer composition may be formed by crosslinking the branched polyimide with (c) at least one polyisocyanate having on average at least two isocyanate groups per molecule. Each of (α) the at least one polyisocyanate having on average at least two isocyanate groups per molecule, (β) the at least one polycarboxylic acid having at least 3 COOH groups per molecule or an anhydride or ester thereof, (b) the at least one diol or triol, and (c) the at least one polyisocyanate having on average at least two isocyanate groups per molecule may be as described herein.

Turning now to the figures, FIG. 1 shows a specific example of an article that can be used in an electrochemical cell according to one set of embodiments. As shown in this exemplary embodiment, article 10 includes an electrode 15 (e.g., an anode or a cathode) comprising an electroactive layer 20. The electroactive layer comprises an electroactive material (e.g., lithium metal). In certain embodiments, the electroactive layer may be covered by a protective structure 30, which can include, for example, an ion conductive layer 30a disposed on an active surface 20′ of the electroactive layer 20 and a polymer layer 30b formed from the polymers disclosed herein and disposed on the ion conductive layer 30a. The protective structure may, in some embodiments, act as an effective barrier to protect the electroactive material from reaction with certain species in the electrolyte. In some embodiments, article 10 includes an electrolyte 40, which may be positioned adjacent the protective structure, e.g., on a side opposite the electroactive layer. The electrolyte can function as a medium for the storage and transport of ions. In some instances, electrolyte 40 may comprise a gel polymer electrolyte formed from the compositions disclosed herein.

A layer referred to as being “covered by,” “on,” or “adjacent” another layer means that it can be directly covered by, on, or adjacent the layer, or an intervening layer may also be present. For example, a polymer layer described herein (e.g., a polymer layer used as a protective layer) that is adjacent an anode or cathode may be directly adjacent the anode or cathode, or an intervening layer (e.g., another protective layer) may be positioned between the anode and the polymer layer. A layer that is “directly adjacent,” “directly on,” or “in contact with,” another layer means that no intervening layer is present. It should also be understood that when a layer is referred to as being “covered by,” “on,” or “adjacent” another layer, it may be covered by, on or adjacent the entire layer or a part of the layer.

It should be appreciated that FIG. 1 is an exemplary illustration and that in some embodiments, not all components shown in the figure need be present. In yet other embodiments, additional components not shown in the figure may be present in the articles described herein. For example, in some cases, protective structure 30 may be a multilayer structure including 3, 4, 5, or more layers, as described in more detail below. In another example, although FIG. 1 shows an ion conductive layer 30a disposed directly on the surface of the electroactive layer, in other embodiments, polymer layer 30b may be disposed directly on the surface of the electroactive layer. Other configurations are also possible.

As described herein, it may be desirable to determine if a polymer has advantageous properties as compared to other materials for particular electrochemical systems. Therefore, simple screening tests can be employed to help select between candidate materials. One simple screening test includes positioning a layer of the resulting polymer of the desired chemistry in an electrochemical cell, e.g., as a separator in a cell. The electrochemical cell may then undergo multiple discharge/charge cycles, and the electrochemical cell may be observed for whether inhibitory or other destructive behavior occurs compared to that in a control system. If inhibitory or other destructive behavior is observed during cycling of the cell, as compared to the control system, it may be indicative of hydrolysis, or other possible degradation mechanisms of the polymer, within the assembled electrochemical cell. Using the same electrochemical cell it is also possible to evaluate the electrical conductivity and ion conductivity of the polymer using methods known to one of ordinary skill in the art. The measured values may be compared to select between candidate materials and may be used for comparison with the baseline material in the control.

Another simple screening test to determine if a polymer has suitable mechanical strength may be accomplished using any suitable mechanical testing methods including, but not limited to, durometer testing, yield strength testing using a tensile testing machine, and other appropriate testing methods. In one set of embodiments, the polymer has a yield strength that is greater than or equal to the yield strength of the electroactive material (e.g., metallic lithium). For example, the yield strength of the polymer may be greater than approximately 2 times, 3 times, or 4 times the yield strength of electroactive material (e.g., metallic lithium). In some embodiments, the yield strength of the polymer is less than or equal to 10 times, 8 times, 6 times, 5 times, 4 times, or 3 times the yield strength of electroactive material (e.g., metallic lithium). Combinations of the above-referenced ranges are also possible. In one specific embodiment, the yield strength of the polymer is greater than approximately 10 kg/cm² (i.e., approximately 980 kPa). Other yield strengths greater than or less than the above limits are also possible. Other simple tests to characterize the polymers may also be conducted by those of ordinary skill in the art.

In some embodiments, the polymeric materials are stable to an applied pressure of at least 10 kg/cm², at least 20 kg/cm², or at least 30 kg/cm² in a swollen state. In some embodiments, the stability may be determined in the electrolyte solvent to be used with the electrochemical cell. In some embodiments, the electrolyte is 8 wt % lithium bis trifluoromethanesulfonimide and 4 wt % LiNO₂ in a 1:1 mixture by weight of 1,2-dimethoxyethane and 1,3-dioxolane. In some embodiments, the total salt concentration in the electrolyte may be between about 8 and about 24 wt %. Other concentrations are also possible.

In some embodiments, the electrochemical cells described herein can be cycled at relatively high temperatures without experiencing thermal runaway. The term “thermal runaway” is understood by those of ordinary skill in the art, and refers to a situation in which the electrochemical cell cannot dissipate the heat generated during charge and discharge sufficiently fast to prevent uncontrolled temperature increases within the cell. Often, a positive feedback loop can be created during thermal runaway (e.g., the electrochemical reaction produces heat, which increases the rate of the electrochemical reaction, which leads to further production of heat), which can cause electrochemical cells to catch fire. In some embodiments, an electrochemical cell can include a polymer described herein (e.g., as part of a polymer layer, optionally as a polymer electrolyte) the electrolyte (e.g., the polymer material within the electrolyte) can be configured such that thermal runaway is not observed at relatively high temperatures of operation of the electrochemical cell. Not wishing to be bound by any particular theory, a polymer as described herein within the electrolyte (e.g., a polymer as described herein) may slow down the reaction between the lithium (e.g., metallic lithium) and the cathode active material (e.g., sulfur such as elemental sulfur) in the electrochemical cell, inhibiting (e.g., preventing) thermal runaway from taking place. Also, the polymer within the electrolyte may serve as a physical barrier between the lithium and the cathode active material, inhibiting (e.g., preventing) thermal runaway from taking place.

In some embodiments, the polymers described herein may aid in reducing or eliminating thermal runaway. This may be due to the fact that many of the polymers described herein are stable to extremely high temperatures and do not exhibit a glass transition temperature. In some embodiments, the polymers aid in operation of the electrochemical cell (e.g., continuously charged and discharged) at a temperature of up to about 130° C., up to about 150° C., up to about 170° C., up to about 190° C., up to 210° C., up to about 230° C., up to about 250° C., up to about 270° C., up to about 290° C., up to about 300° C., up to about 320° C., up to about 340° C., up to about 360° C., or up to about 370° C. (e.g., as measured at the external surface of the electrochemical cell) without the electrochemical cell experiencing thermal runaway.

The electrochemical cell may be operated at one or more of the above-noted temperatures during the entire operation of the electrochemical cell or during only a portion of the operation of the electrochemical cell. In some embodiments, the electrochemical cell may be operated at one or more of the above-noted temperatures for only short periods of time during operation (e.g., wherein the temperature spikes during operation), for example, for a time period of less than 10 minutes, or less than 5 minutes, or less than 2 minutes, or less than 1 minute, or less than 45 seconds, or less than 30 seconds, or less than 20 seconds, or less than 10 seconds, or less.

In some embodiments, the polymers described herein have a decomposition temperature of greater than or equal to about 200° C., greater than or equal to about 250° C., greater than or equal to about 300° C., greater than or equal to about 350° C., or greater than or equal to about 370° C. The decomposition temperature may be, in some embodiments, less than or equal to about 400° C., or about 450° C. Other ranges are also possible.

In some embodiments, the electrochemical cell can be operated at any of the temperatures outlined above without igniting. In some embodiments, the electrochemical cells described herein can be operated at relatively high temperatures (e.g., any of the temperatures outlined above) without experiencing thermal runaway and without employing an auxiliary cooling mechanism (e.g., a heat exchanger external to the electrochemical cell, active fluid cooling external to the electrochemical cell, and the like).

The presence of thermal runaway in an electrochemical cell can be identified by one of ordinary skill in the art. In some embodiments, thermal runaway can be identified by one or more of melted components, diffusion and/or intermixing between components or materials, the presence of certain side products, and/or ignition of the cell.

In one particular set of embodiments, lithium-sulfur electrochemical cells described herein comprise an anode comprising lithium metal or a lithium metal alloy and a polymer layer comprising a polymeric material. The polymer material has a decomposition temperature of greater than or equal to about 200° C. The electrochemical cell also includes a cathode comprising sulfur. The electrochemical cell is adapted and arranged to be operated at a temperature of greater than or equal to about 150° C. without employing an auxiliary cooling mechanism and without the electrochemical cell experiencing thermal runaway.

The polymer layer formed by a composition described herein may have any suitable thickness. In some embodiments, the thickness may vary over a range from about 0.1 microns to about 20 microns. For instance, the thickness of the polymer layer may be between 0.05-0.15 microns thick, between 0.1-1 microns thick, between 1-5 microns thick, or between 5-10 microns thick. The thickness of a polymer layer may be, for example, less than or equal to 10 microns, less than or equal to 5 microns, less than or equal to 2.5 microns, less than or equal to 1 micron, less than or equal to 500 nm, less than or equal to 250 nm, less than or equal to 100 nm, less than or equal to 50 nm, less than or equal to 25 nm, or less than or equal to 10 nm. In certain embodiments, the polymer layer may have a thickness of greater than 10 nm, greater than 25 nm, greater than 50 nm, greater than 100 nm, greater than 250 nm, greater than 500 nm, greater than 1 micron, greater than 1.5 microns. In some embodiments, the polymer layer may have a thickness of 1 micron. Other thicknesses are also possible. Combinations of the above-noted ranges are also possible (e.g., a thickness of greater than 10 nm and less than or equal to 1 micron). In embodiments wherein the polymer is to be employed as a separator, the thickness may be, for example, between about 1 micron and about 20 microns. In embodiments wherein the polymer is to be employed as a gel polymer layer, the thickness may be, for example, between about 1 micron and about 10 microns. In embodiments wherein the polymer is to be employed as a protective layer, the thickness may be, for example, about 1 microns. In one particular set of embodiments, the thickness of the protective layer may be between about 1 micron and about 5 microns, or between about 300 nm and about 3 microns.

As described herein, in some embodiments, ionic compounds (i.e., salts) may be included in the disclosed polymer compositions. In some embodiments, the conductivity of the polymer is determined in the swollen (e.g., gel) state. The gel state ion conductivity (i.e., the ion conductivity of the material when swollen with an electrolyte) of the polymer layers may vary over a range from, for example, about 10⁻⁷ S/cm to about 10⁻³ S/cm. In some embodiments, the gel state ion conductivity is between about 0.1 mS/cm and about 1 mS/cm, or between about 0.1 mS/cm and about 0.9 mS/cm, or between about 0.15 mS/cm and about 0.85 mS/cm. In certain embodiments, the gel state ion conductivity may be greater than or equal to 10⁻⁶ S/cm, greater than or equal to 10⁻⁵ S/cm, greater than or equal to 10⁻⁴ S/cm. In some embodiments, the gel state ion conductivity may be, for example, less than or equal to 10⁻³ S/cm, less than or equal to 10⁻⁴ S/cm, less than or equal to 10⁻⁵ S/cm. Combinations of the above-referenced ranges are also possible (e.g., a gel state ion conductivity of greater than or equal to greater than or equal to 10⁻⁵ S/cm and less than or equal to 10⁻³ S/cm). Other gel state ion conductivities are also possible. In some embodiments, the gel state conductivity may be determined in the electrolyte solvent to be used with the electrochemical cell. In some embodiments, the electrolyte is 8 wt % lithium bis trifluoromethanesulfonimide and 4 wt % LiNO₂ in a 1:1 mixture by weight of 1,2-dimethoxyethane and 1,3-dioxolane.

As shown in FIG. 1, in one set of embodiments, an article for use in an electrochemical cell may include an ion-conductive layer. In some embodiments, the -ion conductive layer is a ceramic layer, a glassy layer, or a glassy-ceramic layer, e.g., an ion conducting ceramic/glass conductive to lithium ions. Suitable glasses and/or ceramics include, but are not limited to, those that may be characterized as containing a “modifier” portion and a “network” portion, as known in the art. The modifier may include a metal oxide of the metal ion conductive in the glass or ceramic. The network portion may include a metal chalcogenide such as, for example, a metal oxide or sulfide. For lithium metal and other lithium-containing electrodes, an ion conductive layer may be lithiated or contain lithium to allow passage of lithium ions across it. Ion conductive layers may include layers comprising a material such as lithium nitrides, lithium silicates, lithium borates, lithium aluminates, lithium phosphates, lithium phosphorus oxynitrides, lithium silicosulfides, lithium germanosulfides, lithium oxides (e.g., Li₂O, LiO, LiO₂, LiRO₂, where R is a rare earth metal), lithium lanthanum oxides, lithium titanium oxides, lithium borosulfides, lithium aluminosulfides, and lithium phosphosulfides, and combinations thereof. The selection of the ion conducting material will be dependent on a number of factors including, but not limited to, the properties of electrolyte and cathode used in the cell.

In one set of embodiments, the ion conductive layer is a non-electroactive metal layer. The non-electroactive metal layer may comprise a metal alloy layer, e.g., a lithiated metal layer especially in the case where a lithium anode is employed. The lithium content of the metal alloy layer may vary from about 0.5% by weight to about 20% by weight, depending, for example, on the specific choice of metal, the desired lithium ion conductivity, and the desired flexibility of the metal alloy layer. Suitable metals for use in the ion conductive material include, but are not limited to, Al, Zn, Mg, Ag, Pb, Cd, Bi, Ga, In, Ge, Sb, As, and Sn. Sometimes, a combination of metals, such as the ones listed above, may be used in an ion conductive material.

The thickness of an ion conductive material layer may vary over a range from about 1 nm to about 10 microns. For instance, the thickness of the ion conductive material layer may be between 1-10 nm thick, between 10-100 nm thick, between 100-1000 nm thick, between 1-5 microns thick, or between 5-10 microns thick. In some embodiments, the thickness of an ion conductive material layer may be, for example, less than or equal to 10 microns, less than or equal to 5 microns, less than or equal to 1000 nm, less than or equal to 500 nm, less than or equal to 250 nm, less than or equal to 100 nm, less than or equal to 50 nm, less than or equal to 25 nm, or less than or equal to 10 nm. In certain embodiments, the ion conductive layer may have a thickness of greater than or equal to 10 nm, greater than or equal to 25 nm, greater than or equal to 50 nm, greater than or equal to 100 nm, greater than or equal to 250 nm, greater than or equal to 500 nm, greater than or equal to 1000 nm, or greater than or equal to 1500 nm. Combinations of the above-referenced ranges are also possible (e.g., a thickness of greater than or equal to 10 nm and less than or equal to 500 nm). Other thicknesses are also possible. In some cases, the ion conductive layer has the same thickness as a polymer layer in a multi-layered structure.

The ion conductive layer may be deposited by any suitable method such as sputtering, electron beam evaporation, vacuum thermal evaporation, laser ablation, chemical vapor deposition (CVD), thermal evaporation, plasma enhanced chemical vacuum deposition (PECVD), laser enhanced chemical vapor deposition, and jet vapor deposition. The technique used may depend on the type of material being deposited, the thickness of the layer, etc.

In some embodiments, the ion conductive material is non-polymeric. In certain embodiments, the ion conductive material is defined in part or in whole by a layer that is highly conductive toward lithium ions (or other ions) and minimally conductive toward electrons. In other words, the ion conductive material may be one selected to allow certain ions, such as lithium ions, to pass across the layer, but to impede electrons, from passing across the layer. In some embodiments, the ion conductive material forms a layer that allows only a single ionic species to pass across the layer (i.e., the layer may be a single-ion conductive layer). In other embodiments, the ion conductive material may be substantially conductive to electrons.

In one set of embodiments, the ion conductive layer is a ceramic layer, a glassy layer, or a glassy-ceramic layer, e.g., an ion-conducting glass conductive to ions (e.g., lithium ions). For lithium metal and other lithium-containing electrodes, an ion conductive layer may be lithiated or contain lithium to allow passage of lithium ions across it. Ion conductive layers may include layers comprising a material such as lithium nitrides, lithium silicates, lithium borates, lithium aluminates, lithium phosphates, lithium phosphorus oxynitrides, lithium silicosulfides, lithium germanosulfides, lithium oxides (e.g., Li₂O, LiO, LiO₂, LiRO₂, where R is a rare earth metal), lithium lanthanum oxides, lithium titanium oxides, lithium borosulfides, lithium aluminosulfides, and lithium phosphosulfides, and combinations thereof. The selection of the ion conducting material will be dependent on a number of factors including, but not limited to, the properties of electrolyte and cathode used in the cell.

The ion conductive layer may be formed using plasma conversion based techniques, electron beam evaporation, magnetron sputtering, chemical vapor deposition, and any other appropriate formation technique, deposition technique, and/or any appropriate combination thereof. Alternatively, the layer of electroactive material may be exposed to a gas, such as nitrogen, under suitable conditions to react with the electroactive material at the surface of the electroactive material layer to form the ion conductive layer.

The noted conversion and/or deposition processes may be performed at any suitable temperature and pressure. However, in some embodiments, the process is performed at a temperature less than the melting temperature of the underlying substrate. In some embodiments, the temperature may be, for example, less than 180° C., less than 150° C., less than 120° C., less than 100° C., less than 80° C., less than 60° C., or less than 40° C. In certain embodiments, the temperature may be greater than 40° C., greater than 60° C., greater than 80° C., greater than 100° C., greater than 120° C., or greater than 150° C. Other temperatures are also possible. Combinations of the above-noted ranges are also possible.

The thickness of an ion conductive material layer may vary over a range from about 1 nm to about 10 microns. For instance, the thickness of the ion conductive material layer may be between 1-10 nm thick, between 10-100 nm thick, between 100-1000 nm thick, between 1-5 microns thick, or between 5-10 microns thick. In some embodiments, the thickness of a ion conductive material layer may be no greater than, e.g., 10 microns thick, no greater than 5 microns thick, no greater than 1000 nm thick, no greater than 500 nm thick, no greater than 250 nm thick, no greater than 100 nm thick, no greater than 50 nm thick, no greater than 25 nm thick, or no greater than 10 nm thick. In certain embodiments, the ion conductive layer may have a thickness of greater than 10 nm, greater than 25 nm, greater than 50 nm, greater than 100 nm, greater than 250 nm, greater than 500 nm, greater than 1000 nm, or greater than 1500 nm. Other thicknesses are also possible. Combinations of the above-noted ranges are also possible. In some cases, the ion conductive layer has the same thickness as a polymer layer in a multi-layered structure.

The ion conductive layer may be deposited by any suitable method such as sputtering, electron beam evaporation, vacuum thermal evaporation, laser ablation, chemical vapor deposition (CVD), thermal evaporation, plasma enhanced chemical vacuum deposition (PECVD), laser enhanced chemical vapor deposition, and jet vapor deposition. The technique used may depend on the type of material being deposited, the thickness of the layer, etc.

In addition to the structures depicted in FIG. 1, the electrochemical cell may include a structure including one or more layers of the disclosed polymer and/or one or more layers of an ion conductive material positioned between the active surface of the electroactive material and the corresponding electrolyte of the cell. The one or more polymer layers and/or one or more ion conductive materials may form a multi-layered structure as described herein.

One advantage of a multi-layered structure includes the mechanical properties of the structure. The positioning of a polymer layer adjacent an ion conductive layer can decrease the tendency of the ion conductive layer to crack, and can increase the barrier properties of the structure. Thus, these laminates or composite structures may be more robust towards stress due to handling during the manufacturing process than structures without intervening polymer layers. In addition, a multi-layered structure can also have an increased tolerance of the volumetric changes that accompany the migration of lithium back and forth from the anode during the cycles of discharge and charge of the cell.

One structure corresponding to such an embodiment is depicted in FIG. 2A. In the depicted embodiment, article 10 includes an electrode 17 (e.g., an anode or a cathode) comprising an electroactive layer 20. The electroactive layer comprises an electroactive material (e.g., lithium metal). In certain embodiments, the electroactive layer is covered by structure 30. As shown in the illustrative embodiment, structure 30 is disposed on the electroactive layer 20 and is a multi-layered structure including at least a first polymeric layer 30b formed from the polymers disclosed herein and positioned adjacent the electroactive layer, and at least a first ion conductive layer 30a positioned adjacent the first polymer layer. In this embodiment, the multi-layered structure can optionally include several sets of alternating ion conductive material layers 30a and polymeric layers 30b. The multi-layered structures can allow passage of, for example, lithium ions, while limiting passage of certain chemical species that may adversely affect the anode (e.g., species in the electrolyte). This arrangement can provide significant advantage, as the polymers can be selected to impart flexibility to the system where it can be needed most, namely, at the surface of the electrode where morphological changes occur upon charge and discharge. Although FIG. 2A shows a first polymeric layer 30b positioned directly adjacent the electroactive layer, in other embodiments, an ion conductive layer 30a may be directly adjacent the electroactive layer. Other configurations are also possible.

In other embodiments, as depicted in FIG. 2B, the electroactive layer may be covered by structure 30 formed from a single polymer layer 30b. Polymer layer 30b may be formed from the polymers disclosed herein and may be disposed on active surface 20′ of the electroactive layer.

A multi-layered structure may have various overall thicknesses that can depend on, for example, the electrolyte, the cathode, or the particular use of the electrochemical cell. In some cases, a multi-layered structure can have an overall thickness less than or equal to 1 mm, less than or equal to 700 microns, less than or equal to 300 microns, less than or equal to 250 microns, less than or equal to 200 microns, less than or equal to 150 microns, less than or equal to 100 microns, less than or equal to 75 microns, less than or equal to 50 microns, less than or equal to 20 microns, less than or equal to 10 microns, less than or equal to 5 microns, or less than or equal to 2 microns. In certain embodiments, the multi-layered structure may have a thickness of greater than 100 nm, greater than 250 nm, greater than 500 nm, greater than 1 micron, greater than 2 microns, greater than 5 microns, greater than 10 microns, or greater than 20 microns. Other thicknesses are also possible. Combinations of the above-noted ranges are also possible.

Examples of multi-layered structures are described in more detail in U.S. patent application Ser. No. 11/400,025, issued as U.S. Pat. No. 7,771,870, and entitled “Electrode Protection in both Aqueous and Non-Aqueous Electrochemical Cells, including Rechargeable Lithium Batteries,” which is incorporated herein by reference in its entirety for all purposes.

As shown in the embodiment illustrated in FIG. 3, article 10 comprising anode 19 may be incorporated with other components to form an electrochemical cell 12. The electrochemical cell may optionally include a separator 50 positioned adjacent or within the electrolyte. The electrochemical cell may further include a cathode 60 comprising a cathode active material. Similar to above, a protective structure 30 may be incorporated between the electroactive layer 20 and electrolyte layer 40 and cathode 60. In the illustrative embodiment of FIG. 3, protective structure 30 comprises a plurality of ion conductive layers 30a and polymer layers 30b. The ion conductive layers 30a and polymer layers 30b are arranged in an alternating pattern. The polymer layers 30b may be formed from the polymer compositions disclosed herein. While four separate layers have been depicted, it should be appreciated that any suitable number of desired layers could be used (e.g., 5, 6, 7, 8 separate layers).

In some embodiments, the polymers disclosed herein may also be employed as a separator (e.g., 50 in FIG. 3). Generally, a separator is interposed between a cathode and an anode in an electrochemical cell. The separator may separates or insulates the anode and the cathode from each other preventing short circuiting, and which permits the transport of ions between the anode and the cathode. The separator may be porous, wherein the pores may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes.

In another set of embodiments, electrolyte layer 40, as shown illustratively in FIG. 3, may comprise a polymer gel formed from the polymers disclosed herein. As known to those of ordinary skill in the art, when a solvent is added to a polymer and the polymer is swollen in the solvent to form a gel, the polymer gel is more easily deformed (and, thus, has a lower yield strength) than the polymer absent the solvent. The yield strength of a particular polymer gel may depend on a variety of factors such as the chemical composition of the polymer, the molecular weight of the polymer, the degree of crosslinking of the polymer if any, the thickness of the polymer gel layer, the chemical composition of the solvent used to swell the polymer, the amount of solvent in the polymer gel, any additives such as salts added to the polymer gel, the concentration of any such additives, and the presence of any cathode discharge products in the polymer gel.

In some embodiments, the polymer gel is formed by swelling at least a portion of the polymer in a solvent to form the gel. The polymers may be swollen in any appropriate solvent. The solvent may include, for example, dimethylacetamide (DMAc), N-methylpyrolidone (NMP), dimethylsulfoxide (DMSO), dimethylformamide (DMF), sulfolanes, sulfones, and/or any other appropriate solvent. In certain embodiments, the polymer may be swollen in a solvent mixture comprising a solvent having affinity to polymer and also solvents having no affinity to the polymer (so-called non-solvents) such as, for PVOH, 1,2.dimethoxyethane (DME), diglyme, triglyme, 1.3-dioxolane (DOL), THF, 1,4-dioxane, cyclic and linear ethers, esters (carbonates such as dimethylcarbonate and ethylene carbonate), acetals and ketals. In some embodiments, the polymers are swellable in 1,2-dimethoxyethane and/or 1,3-dioxolane solvents. The solvents for preparing the polymer gel may be selected from the solvents described herein and may comprise electrolyte salts, including lithium salts selected from the lithium salts described herein.

In embodiments where more than one solvent is employed, the solvents may be present in any suitable ratio, for example, at a ratio of a first solvent to a second solvent of about 1:1, about 1.5:1, about 2:1, about 1:1.5, or about 1:2. In certain embodiments, the ratio of the first and second solvents may between 100:1 and 1:100, or between 50:1 and 1:50, or between 25:1 and 1:25, or between 10:1 and 1:10, or between 5:1 and 1:5. In some embodiments, the ratio of a first solvent to a second solvent is greater than or equal to about 0.2:1, greater than or equal to about 0.5:1, greater than or equal to about 0.8:1, greater than or equal to about 1:1, greater than or equal to about 1.2:1, greater than or equal to about 1.5:1, greater than or equal to about 1.8:1, greater than or equal to about 2:1, or greater than or equal to about 5:1. The ratio of a first solvent to a second solvent may be less than or equal to about 5:1, less than or equal to about 2:1, less than or equal to about 1.8:1, less than or equal to about 1.5:1, less than or equal to about 1.2:1, less than or equal to about 1:1, less than or equal to about 0.8:1, or less than or equal to about 0.5:1. Combinations of the above-referenced ranges are also possible (e.g., a ratio of greater than or equal to about 0.8:1 and less than or equal to about 1.5:1). In some embodiments, the first solvent is 1,2-dimethoxyethane and the second solvent is 1,3-dioxolane, although it should be appreciated that any of the solvents described herein can be used as first or second solvents. Additional solvents (e.g., a third solvent) may also be included.

In some embodiments, a polymer layer (e.g., a protective polymer layer or a polymer gel layer) and/or an electrolyte may include one or more ionic electrolyte salts, also as known in the art, to increase the ionic conductivity. In some embodiments, the salt can be selected from salts of lithium or sodium. In particular, if the anode or cathode contains lithium, the salt can be selected from lithium salts.

Suitable lithium salts may be selected from LiNO₃, LiPF₆, LiBF₄, LiClO₄, LiAsF₆, Li₂SiF₆, LiSbF₆, LiAlCl₄, lithium bis-oxalatoborate (LiBOB), LiCF₃SO₃, LiN(SO₂F)₂, LiC(CₙF₂ₙ₊₁SO₂)ₘXLi wherein n is an integer in the range of from 1 to 20, and salts of the general formula (CₙF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicium (silicon) and n is an integer in the range of from 1 to 20. In certain embodiments, suitable salts may be selected from LiC(CF₃SO₂)₃, LiN(CF₃SO₂)₂, LiN(SO₂F)₂, LiPF₆, LiBF₄, LiClO₄, and LiCF₃SO₃.

The concentration of salt in a solvent can be in the range of from about 0.5 to about 2.0 M, from about 0.7 to about 1.5 M, or from about 0.8 to about 1.2 M (wherein M signifies molarity, or moles per liter). The amount of salt can also vary when present in a layer (e.g., a polymer layer).

As shown illustratively in FIG. 3, an electrochemical cell or an article for use in an electrochemical cell may include a cathode active material layer. Suitable electroactive materials for use as cathode active materials in the cathode of the electrochemical cells described herein may include, but are not limited to, electroactive transition metal chalcogenides, electroactive conductive polymers, sulfur, carbon, and/or combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of this invention may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

Suitable electroactive materials for use as anode active materials in the electrochemical cells described herein include, but are not limited to, lithium metal such as lithium foil and lithium deposited onto a conductive substrate, and lithium alloys (e.g., lithium-aluminum alloys and lithium-tin alloys). Lithium can be contained as one film or as several films, optionally separated by a protective material such as a ceramic material or an ion conductive material described herein. Suitable ceramic materials include silica, alumina, or lithium containing glassy materials such as lithium phosphates, lithium aluminates, lithium silicates, lithium phosphorous oxynitrides, lithium tantalum oxide, lithium aluminosulfides, lithium titanium oxides, lithium silcosulfides, lithium germanosulfides, lithium aluminosulfides, lithium borosulfides, and lithium phosphosulfides, and combinations of two or more of the preceding. Suitable lithium alloys for use in the embodiments described herein can include alloys of lithium and aluminum, magnesium, silicium (silicon), indium, and/or tin. While these materials may be preferred in some embodiments, other cell chemistries are also contemplated. In some embodiments, the anode may comprise one or more binder materials (e.g., polymers, etc.).

The articles described herein may further comprise a substrate, as is known in the art. Substrates are useful as a support on which to deposit the anode active material, and may provide additional stability for handling of thin lithium film anodes during cell fabrication. Further, in the case of conductive substrates, a substrate may also function as a current collector useful in efficiently collecting the electrical current generated throughout the anode and in providing an efficient surface for attachment of electrical contacts leading to an external circuit. A wide range of substrates are known in the art of anodes. Suitable substrates include, but are not limited to, those selected from the group consisting of metal foils, polymer films, metallized polymer films, electrically conductive polymer films, polymer films having an electrically conductive coating, electrically conductive polymer films having an electrically conductive metal coating, and polymer films having conductive particles dispersed therein. In one embodiment, the substrate is a metallized polymer film. In other embodiments, described more fully below, the substrate may be selected from non-electrically-conductive materials.

The electrolytes used in electrochemical or battery cells can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material facilitates the transport of ions (e.g., lithium ions) between the anode and the cathode. The electrolyte is electronically non-conductive to prevent short circuiting between the anode and the cathode. In some embodiments, the electrolyte may comprise a non-solid electrolyte.

In some embodiments, an electrolyte layer described herein may have a thickness of at least 1 micron, at least 5 microns, at least 10 microns, at least 15 microns, at least 20 microns, at least 25 microns, at least 30 microns, at least 40 microns, at least 50 microns, at least 70 microns, at least 100 microns, at least 200 microns, at least 500 microns, or at least 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 50 microns. Other values are also possible. Combinations of the above-noted ranges are also possible.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, acyclic ethers, cyclic ethers, glymes, polyethers, phosphate esters, siloxanes, dioxolanes, N-alkylpyrrolidones, substituted forms of the foregoing, and blends thereof. Examples of acyclic ethers that may be used include, but are not limited to, diethyl ether, dipropyl ether, dibutyl ether, dimethoxymethane, trimethoxymethane, dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents. Mixtures of the solvents described herein can also be used.

The term “aliphatic,” as used herein, includes both saturated and unsaturated, straight chain (i.e., unbranched), branched, acyclic, cyclic, or polycyclic aliphatic hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched, and cyclic alkyl groups. An analogous convention applies to other generic terms such as “alkenyl,” “alkynyl,” and the like. Furthermore, as used herein, the terms “alkyl,” “alkenyl,” “alkynyl,” and the like encompass both substituted and unsubstituted groups. In certain embodiments, as used herein, “lower alkyl” is used to indicate those alkyl groups (cyclic, acyclic, substituted, unsubstituted, branched or unbranched) having 1-6 carbon atoms.

In certain embodiments, the alkyl, alkenyl, and alkynyl groups employed in the c compounds described herein contain 1-20 aliphatic carbon atoms. For example, in some embodiments, an alkyl, alkenyl, or alkynyl group may have greater than or equal to 2 carbon atoms, greater than or equal to 4 carbon atoms, greater than or equal to 6 carbon atoms, greater than or equal to 8 carbon atoms, greater than or equal to 10 carbon atoms, greater than or equal to 12 carbon atoms, greater than or equal to 14 carbon atoms, greater than or equal to 16 carbon atoms, or greater than or equal to 18 carbon atoms. In some embodiments, an alkyl, alkenyl, or alkynyl group may have less than or equal to 20 carbon atoms, less than or equal to 18 carbon atoms, less than or equal to 16 carbon atoms, less than or equal to 14 carbon atoms, less than or equal to 12 carbon atoms, less than or equal to 10 carbon atoms, less than or equal to 8 carbon atoms, less than or equal to 6 carbon atoms, less than or equal to 4 carbon atoms, or less than or equal to 2 carbon atoms. Combinations of the above-noted ranges are also possible (e.g., greater than or equal to 2 carbon atoms and less than or equal to 6 carbon atoms). Other ranges are also possible.

Illustrative aliphatic groups include, but are not limited to, for example, methyl, ethyl, n-propyl, isopropyl, cyclopropyl, —CH₂-cyclopropyl, vinyl, allyl, n-butyl, sec-butyl, isobutyl, tert-butyl, cyclobutyl, —CH₂-cyclobutyl, n-pentyl, sec-pentyl, isopentyl, tert-pentyl, cyclopentyl, —CH₂-cyclopentyl, n-hexyl, sec-hexyl, cyclohexyl, —CH₂-cyclohexyl moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl, and the like.

The term “alkoxy,” or “thioalkyl” as used herein refers to an alkyl group, as previously defined, attached to the parent molecule through an oxygen atom or through a sulfur atom. In certain embodiments, the alkoxy or thioalkyl groups contain a range of carbon atoms, such as the ranges of carbon atoms described herein with respect to the alkyl, alkenyl, or alkynyl groups. Examples of alkoxy, include but are not limited to, methoxy, ethoxy, propoxy, isopropoxy, n-butoxy, tert-butoxy, neopentoxy, and n-hexoxy. Examples of thioalkyl include, but are not limited to, methylthio, ethylthio, propylthio, isopropylthio, n-butylthio, and the like.

The term “alkylamino” refers to a group having the structure —NHR′, wherein R′ is aliphatic, as defined herein. In certain embodiments, the alkylamino groups contain a range of carbon atoms, such as the ranges of carbon atoms described herein with respect to the alkyl, alkenyl, or alkynyl groups. Examples of alkylamino groups include, but are not limited to, methylamino, ethylamino, n-propylamino, iso-propylamino, cyclopropylamino, n-butylamino, tert-butylamino, neopentylamino, n-pentylamino, hexylamino, cyclohexylamino, and the like.

The term “dialkylamino” refers to a group having the structure —NRR′, wherein R and R′ are each an aliphatic group, as defined herein. In some cases, R and R′ may be R₁ or R₂, as described herein. R and R′ may be the same or different in an dialkylamino moiety. In certain embodiments, the dialkylamino groups contain a range of carbon atoms, such as the ranges of carbon atoms described herein with respect to the alkyl, alkenyl, or alkynyl groups. Examples of dialkylamino groups include, but are not limited to, dimethylamino, methyl ethylamino, diethylamino, methylpropylamino, di(n-propyl)amino, di(iso-propyl)amino, di(cyclopropyl)amino, di(n-butyl)amino, di(tert-butyl)amino, di(neopentyl)amino, di(n-pentyl)amino, di(hexyl)amino, di(cyclohexyl)amino, and the like. In certain embodiments, R and R′ are linked to form a cyclic structure. The resulting cyclic structure may be aromatic or non-aromatic. Examples of cyclic diaminoalkyl groups include, but are not limited to, aziridinyl, pyrrolidinyl, piperidinyl, morpholinyl, pyrrolyl, imidazolyl, 1,3,4-trianolyl, and tetrazolyl.

Some examples of substituents of the above-described aliphatic (and other) moieties of compounds of the invention include, but are not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

In general, the terms “aryl” and “heteroaryl”, as used herein, refer to stable mono- or polycyclic, heterocyclic, polycyclic, and polyheterocyclic unsaturated moieties having preferably 3-14 carbon atoms, each of which may be substituted or unsubstituted. Substituents include, but are not limited to, any of the previously mentioned substituents, i.e., the substituents recited for aliphatic moieties, or for other moieties as disclosed herein, resulting in the formation of a stable compound. In certain embodiments described herein, “aryl” refers to a mono- or bicyclic carbocyclic ring system having one or two aromatic rings including, but not limited to, phenyl, naphthyl, tetrahydronaphthyl, indanyl, indenyl, and the like. In certain embodiments, the term “heteroaryl”, as used herein, refers to a cyclic aromatic radical having from five to ten ring atoms of which one ring atom is selected from S, O, and N; zero, one, or two ring atoms are additional heteroatoms independently selected from S, O, and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like.

It will be appreciated that aryl and heteroaryl groups can be unsubstituted or substituted, wherein substitution includes replacement of one, two, three, or more of the hydrogen atoms thereon independently with any one or more of the following moieties including, but not limited to: aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “cycloalkyl,” as used herein, refers specifically to groups having three to seven, preferably three to ten carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or heterocyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “heteroaliphatic”, as used herein, refers to aliphatic moieties that contain one or more oxygen, sulfur, nitrogen, phosphorus, or silicon atoms, e.g., in place of carbon atoms. Heteroaliphatic moieties may be branched, unbranched, cyclic or acyclic and include saturated and unsaturated heterocycles such as morpholino, pyrrolidinyl, etc. In certain embodiments, heteroaliphatic moieties are substituted by independent replacement of one or more of the hydrogen atoms thereon with one or more moieties including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The terms “halo” and “halogen” as used herein refer to an atom selected from fluorine, chlorine, bromine, and iodine.

The term “haloalkyl” denotes an alkyl group, as defined above, having one, two, or three halogen atoms attached thereto and is exemplified by such groups as chloromethyl, bromoethyl, trifluoromethyl, and the like.

The term “heterocycloalkyl” or “heterocycle”, as used herein, refers to a non-aromatic 5-, 6-, or 7-membered ring or a polycyclic group, including, but not limited to a bi- or tri-cyclic group comprising fused six-membered rings having between one and three heteroatoms independently selected from oxygen, sulfur and nitrogen, wherein (i) each 5-membered ring has 0 to 1 double bonds and each 6-membered ring has 0 to 2 double bonds, (ii) the nitrogen and sulfur heteroatoms may be optionally be oxidized, (iii) the nitrogen heteroatom may optionally be quaternized, and (iv) any of the above heterocyclic rings may be fused to a benzene ring. Representative heterocycles include, but are not limited to, pyrrolidinyl, pyrazolinyl, pyrazolidinyl, imidazolinyl, imidazolidinyl, piperidinyl, piperazinyl, oxazolidinyl, isoxazolidinyl, morpholinyl, thiazolidinyl, isothiazolidinyl, and tetrahydrofuryl. In certain embodiments, a “substituted heterocycloalkyl or heterocycle” group is utilized and as used herein, refers to a heterocycloalkyl or heterocycle group, as defined above, substituted by the independent replacement of one, two or three of the hydrogen atoms thereon with but are not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples which are described herein.

The term “independently selected” is used herein to indicate that the R groups can be identical or different.

### EXAMPLES

Non-limiting examples of the polymers described herein are illustrated by the following working examples.

### General Remarks:

Polyisocyanate (α.1): polymeric 4,4′-diphenylmethane diisocyanate (“Polymer-MDI”), average of 2.7 isocyanate groups per molecule, dynamic viscosity: 195 mPa·s at 25° C., commercially available as Lupranat® M20W.

Polyisocyanate (α.2): isocyanurate from hexamethylenediisocyanate, average of 3,6 isocyanate groups per molecule.

Polyisocyanate (α.3): 4,4′-diphenylmethane diisocyanate, average of 2 isocyanate groups per molecule, dynamic viscosity: 5 mPa·s at 25° C., commercially available as Lupranat® MES.

Polycarboxylic acid (β.1): dianhydride of 1,2,4,5-benzene tetracarboxylic acid

Diol (b.1): poly-THF having an average molecular weight Mₙ of 1000 g/mol.

Diol (b.2): poly-THF having an average molecular weight Mₙ of 250 g/mol.

Diol (b.3): polypropylenglycol having an average molecular weight Mₙ of 1100 g/mol.

Diol (b.4: polyethyleneglycol having an average molecular weight Mₙ of 1000 g/mol.

Diol (b.5): polyethyleneglycol having an average molecular weight Mₙ of 1500 g/mol.

“NCO”: NCO content, determined by IR spectroscopy unless expressly mentioned otherwise, it is indicated in % by weight.

The molecular weights of the polymers were determined by gel permeation chromatography (GPC using a refractometer as detector). The standard used was polymethyl methacrylate (PMMA). The solvents used were N,N-dimethylacetamide (DMAc) or tetrahydrofurane (THF), if not stated otherwise.

Percentages are % by weight unless expressly mentioned otherwise.

The molecular weights were determined by gel-permeation chromatography (GPC). The standard used was polystyrene (PS). The solvent used was tetrahydrofuran (THF), where not explicitly stated otherwise. Detection was performed using an Agilent 1100 differential refractometer or an Agilent 1100 VWD UV photometer. The NCO content was determined titrimetrically as specified in DIN EN ISO 11 909 and reported in % by weight.

The syntheses were carried out under nitrogen, if not described otherwise.

### I. Production of Polyimides

### I.1 Synthesis of Reaction Product RP.1:

An amount of 100 g (0.46 mol) of polycarboxylic acid (β.1) were dissolved in 1400 ml of acetone which was not dried before the reaction and therefore comprised water and placed in a 4-1 four-neck flask having a dropping funnel, reflux cooler, internal thermometer and Teflon agitator. Then, 173 g (0.69 mol) of polyisocyanate (α.1) were added dropwise at 20° C. The mixture was heated with stirring to 55° C. The mixture was stirred for a further six hours under reflux at 55° C. Thereafter, 600 g of diol (b.1) (0.6 mol) were added. The temperature was increased to 60° C. and acetone was distilled off at atmospheric pressure in the course of 4 hours. Thereafter, the mixture was heated to 125° C. and the pressure decreased to 200 mbar. Thereafter, the resulting residue was stripped in the flask with nitrogen. This produced reaction product RP.1 as a solid yellow mass. Mₙ=8,360 g/mol, M_{w}=21,000 g/mol. M_{w}/Mₙ=2.5. OH number: 22 mg KOH/g. Acid value: 88 mg KOH/g.

### I.2 Synthesis of Reaction Product RP.2:

An amount of 100 g (0.46 mol) of polycarboxylic acid (β.1) were dissolved in 1400 ml of acetone which was not dried before the reaction and therefore comprised water and placed in a 4-1 four-neck flask having a dropping funnel, reflux cooler, internal thermometer and Teflon agitator. Then 115 g (0.46 mol) of polyisocyanate (α.1) were added dropwise at 20° C. The mixture was heated with stirring to 55° C. The mixture was stirred for a further six hours under reflux at 55° C. Thereafter, 1000 g of diol (b.1) (1.0 mol) were added and the mixture was stirred under reflux at 55° C. for 14 hours. The temperature was increased to 60° C. and acetone was distilled off in the course of 4 hours at atmospheric pressure. Thereafter, the mixture was heated to 125° C. and the pressure was reduced to 200 mbar. Thereafter, the resulting residue was stripped in the flask with nitrogen. This produced reaction product RP.2 as a solid yellow mass. Mₙ=7250 g/mol, M_{w}=16 900 g/mol. M_{w}/Mₙ=2.3. OH number: 26 mg KOH/g. Acid value: 40 mg KOH/g.

### I.3 Synthesis of Reaction Product RP.3:

An amount of 100 g (0.46 mol) of polycarboxylic acid (β.1) were dissolved in 1400 ml of acetone which was not dried before the reaction and therefore comprised water and placed in a 4-1 four-neck flask having a dropping funnel, reflux cooler, internal thermometer and Teflon agitator. Then, 115 g (0.69 mol) of polyisocyanate (α.1) were added dropwise at 20° C. The mixture was heated to 55° C. with stirring. The mixture was stirred for a further six hours under reflux at 55° C. Thereafter, 300 g of diol (b.1) (0.3 mol) were added. The mixture was stirred for a further six hours under reflux at 55° C. and thereafter the temperature was increased to 60° C. and acetone was distilled off in the course of 4 hours at atmospheric pressure. Thereafter, the mixture was heated to 125° C. and the pressure was reduced to 200 mbar. Thereafter, the residue was stripped in the flask with nitrogen. This produced reaction product RP.3 as a solid yellow mass. Mₙ=3670 g/mol, M_{w}=11 900 g/mol. M_{w}/Mₙ=3.2. OH number: 37 mg KOH/g. Acid value: 144 mg KOH/g.

### I.4 Synthesis of Reaction Product RP.4:

An amount of 100 g (0.46 mol) of polycarboxylic acid (β.1) were dissolved in 1400 ml of acetone which was not dried before the reaction and therefore comprised water and placed in a 4-1 four-neck flask having a dropping funnel, reflux cooler, internal thermometer and Teflon agitator. Then, 173 g (0.69 mol) of polyisocyanate (α.1) were added dropwise at 20° C. The mixture was heated to 55° C. with stirring. The mixture was stirred for a further five hours under reflux at 55° C. Thereafter, 390 g of diol (b.1) (0.6 mol) were added. The temperature was increased to 60° C. and acetone was distilled off in the course of 7 hours at atmospheric pressure. Thereafter, the mixture was heated to 80° C. and the pressure was reduced to 200 mbar. Thereafter, the resulting residue was stripped in the flask with nitrogen. This produced reaction product RP.4 as a solid yellow mass. Mₙ=5900 g/mol, M_{w}=14 000 g/mol. M_{w}/Mₙ=2.4. OH number: 14 mg KOH/g. Acid value: 107 mg KOH/g.

### I.5 Synthesis of Reaction Product RP.5:

An amount of 100 g (0.46 mol) of polycarboxylic acid (β.1) were dissolved in 1400 ml of acetone which was not dried before the reaction and therefore comprised water and placed in a 4-1 four-neck flask having a dropping funnel, reflux cooler, internal thermometer and Teflon agitator. Then, 173 g (0.69 mol) of polyisocyanate (α.1) were added dropwise at 20° C. The mixture was heated to 55° C. with stirring. The mixture was stirred for a further five hours under reflux at 55° C. Thereafter, 173 g of diol (b.2) (0.6 mol) were added. The temperature was increased to 60° C. and acetone was distilled off in the course of 7 hours at atmospheric pressure. Thereafter the mixture was heated to 80° C. and the pressure reduced to 200 mbar. Thereafter, the residue was stripped in the flask with nitrogen. This produced reaction product RP.5 according to the invention as a solid yellow mass. Mₙ=4360 g/mol, M_{w}=8370 g/mol. M_{w}/Mₙ=1.9. OH number: 12 mg KOH/g. Acid value: 151 mg KOH/g.

### I.6 Synthesis of Reaction Product RP.6:

An amount of 100 g (0.46 mol) of polycarboxylic acid (β.1) were dissolved in 1400 ml of acetone which was not dried before the reaction and therefore comprised water and placed in a 4-1 four-neck flask having a dropping funnel, reflux cooler, internal thermometer and Teflon agitator. Then, 115 g (0.46 mol) of isocyanate (α.3) were added dropwise at 20° C. The mixture was heated to 55° C. with stirring. The mixture was stirred for a further five hours under reflux at 55° C. Thereafter, 300 g of diol (b.1) (0.3 mol) were added. The temperature was increased to 55° C. and stirred at this temperature for five hours. Then acetone was distilled off in the course of 6 hours at atmospheric pressure. Thereafter the mixture was heated to 80° C. and the pressure reduced to 200 mbar. This produced reaction product RP.6 according to the invention as a solid yellow mass, which was then dissolved in 530 ml 1,3-dioxolane. Mₙ=3670 g/mol, M_{w}=11900 g/mol. M_{w}/Mₙ=3.2. OH number: 37 mg KOH/g. Acid value: 144 mg KOH/g.

### I.7 Synthesis of Reaction Product RP.7:

An amount of 50 g (0.23 mol) of polycarboxylic acid (β.1) were dissolved in 450 ml of 1,3 dioxolane with 0.45 g of water and placed in a 4-1 four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further five hours at 55° C. Thereafter, 150 g of diol (b.1) (0.15 mol) were added. The temperature was increased to 55° C. and stirred at 55° C. temperature for five hours. This produced reaction product RP.7 according to the invention, which was then dissolved in 1,3-dioxolane. Mₙ=3377 g/mol, M_{w}=9951 g/mol. M_{w}/Mₙ=2.9. OH number: 15 mg KOH/g. Acid value: 77 mg KOH/g.

### I.8 Synthesis of Reaction Product RP.8:

An amount of 50 g (0.23 mol) of polycarboxylic acid (β.1) were dissolved in 700 ml of acetone which was not dried before the reaction and therefore comprised water and placed in a 4-1 four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further seven hours under reflux at 55° C. Thereafter, 75 g of diol (b.1) (0.075 mol) and 82.5 g of diol (b.3) (0.075 mol) were added. The temperature was increased to 55° C. and stirred at this temperature for six hours. Then acetone was distilled off in the course of 3 hours at atmospheric pressure. Thereafter the mixture was heated to 60° C. and the pressure reduced to 200 mbar. This produced reaction product RP.8 according to the invention as a solid yellow mass, which was dissolved in 265 ml 1,3-dioxolane. Mₙ=4064 g/mol, M_{w}=10,560 g/mol. M_{w}/Mₙ=2.6. OH number: 18 mg KOH/g. Acid value: 76 mg KOH/g.

### I.9 Synthesis of Reaction Product RP.9:

An amount of 50 g (0.23 mol) of polycarboxylic acid (β.1) were dissolved in 700 ml of acetone which was not dried before the reaction and therefore comprised water and placed in a 4-1 four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further seven hours under reflux at 55° C. Thereafter, 30 g of diol (b.1) (0.003 mol) and 132 g of diol (b.3) (0.12 mol) were added. The temperature was increased to 55° C. and stirred at this temperature for five hours. Then acetone was distilled off in the course of four hours at atmospheric pressure. Thereafter the mixture was heated to 60° C. and the pressure reduced to 200 mbar. This produced reaction product RP.9 according to the invention as a solid yellow mass, which was dissolved in 270 ml 1,3-dioxolane. Mₙ=3562 g/mol, M_{w}=8536 g/mol. M_{w}/Mₙ=2.4. OH number: 8 mg KOH/g. Acid value: 71 mg KOH/g.

### I.10 Synthesis of Reaction Product RP.10:

An amount of 50 g (0.23 mol) of polycarboxylic acid (β.1) were dissolved in 700 ml of acetone which was not dried before the reaction and therefore comprised water and placed in a 4-1 four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further five hours under reflux at 55° C. Thereafter, 225 g of diol (b.5) (0.15 mol) were added. The temperature was increased to 55° C. and stirred at this temperature for five hours. Then acetone was distilled off in the course of 6 hours at atmospheric pressure. Thereafter the mixture was heated to 60° C. and the pressure reduced to 200 mbar. This produced reaction product RP.10 according to the invention as a solid yellow mass, which was dissolved in 400 ml 1,3-dioxolane. OH number: 9 mg KOH/g. Acid value: 20 mg KOH/g.

### I.11 Synthesis of Reaction Product RP.11:

An amount of 50 g (0.23 mol) of polycarboxylic acid (β.1) were dissolved in 700 ml of acetone which was not dried before the reaction and therefore comprised water and placed in a 4-1 four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further five hours under reflux at 55° C. Thereafter, 150 g of diol (b.4) (0.15 mol) were added. The temperature was increased to 55° C. and stirred at this temperature for five hours. Then acetone was distilled off in the course of 6 hours at atmospheric pressure. Thereafter the mixture was heated to 60° C. and the pressure reduced to 200 mbar. This produced reaction product RP.11 according to the invention as a solid yellow mass, which was then dissolved in 350 ml 1,3-dioxolane. OH number: 12 mg KOH/g. Acid value: 40 mg KOH/g.

### I.12 Synthesis of Reaction Product RP.12:

An amount of 50 g (0.23 mol) of polycarboxylic acid (β.1) were dissolved in 700 ml of acetone which was not dried before the reaction and therefore comprised water and placed in a 4-1 four-neck flask having a dropping funnel, reflux cooler, internal thermometer and Teflon agitator. Then, 115 g (0.46 mol) of isocyanate (α.3) were added dropwise at 20° C. The mixture was heated to 55° C. with stirring. The mixture was stirred for a further six hours under reflux at 55° C. Thereafter, 460 g of diol (b.1) (0.46 mol) were added. The temperature was increased to 55° C. and stirred at this temperature for seven hours. Then acetone was distilled off in the course of two hours at atmospheric pressure. Thereafter the mixture was heated to 60° C. and the pressure reduced to 300 mbar. This produced reaction product RP.12 according to the invention as a solid yellow mass, which was dissolved in 625 ml 1,3-dioxolane. Mₙ=10030 g/mol, M_{w}=22090 g/mol. M_{w}/Mₙ=2.2. OH number: 6 mg KOH/g. Acid value: 26 mg KOH/g.

### I.13 Synthesis of Reaction Product RP.13:

An amount of 100 g (0.46 mol) of polycarboxylic acid (β.1) were dissolved in 1400 ml of acetone, which was not dried before the reaction and therefore comprised water, and placed in a 4-1 four-neck flask having a dropping funnel, reflux cooler, internal thermometer and Teflon agitator. Then, 173 g (0.69 mol) of isocyanate (α.3) were added at 20° C. The mixture was heated to 55° C. with stiffing. The mixture was stirred for a further six hours under reflux at 55° C. Thereafter, 600 g of diol (b.1) (0.60 mol) were added. The temperature was increased to 55° C. and stirred at this temperature for three hours. Then acetone was distilled off in the course of two hours at atmospheric pressure. Thereafter the mixture was heated to 125° C. and the pressure reduced to 300 mbar. This produced reaction product RP.13 according to the invention as a solid yellow mass, which was dissolved in 1000 ml 1,3-dioxolane. Mₙ=7750 g/mol, M_{w}=19600 g/mol. M_{w}/Mₙ=2.5. OH number: 15 mg KOH/g.

Acid value: 91 mg KOH/g.

### I.14 Synthesis of Reaction Product RP.14:

An amount of 100 g (0.46 mol) of polycarboxylic acid (β.1) were dissolved in 600 g of 1,3 dioxolane with 2.5 g of water and placed in a 4-1 four-neck flask having a dropping funnel, reflux cooler, internal thermometer and Teflon agitator. Then, 115 g (0.46 mol) of isocyanate (α.3) were added dropwise at 20° C. The mixture was heated to 55° C. with stirring. The mixture was stirred for a further five hours at 55° C. Thereafter, 330 g of diol (b.3) (0.30 mol) were added. The temperature was increased to 55° C. and stirred at 55° C. temperature for five hours. This produced reaction product RP.14 according to the invention, which was then dissolved in 1,3-dioxolane. Mₙ=3073 g/mol, M_{w}=6412 g/mol. M_{w}/Mₙ=2.1. OH number: 18 mg KOH/g. Acid value: 70 mg KOH/g.

### II. Manufacture of Polymer Layers (e.g., Separators) (D.6) to (D.13)

### General Procedure:

A solution of 20 g of RP.6 in 1,3-dioxolane was provided. The solids content was adjusted by addition of 1,3-dioxolane, if necessary, and then warmed to 80° C. Polyisocyanate (α.1) was added, and the solution so obtained was applied at 80° C. with a doctor blade method to a glass plate. The solvent-containing film so obtained had a thickness of 15 μm. The 1,3-dioxolane was allowed to evaporate for 10 minutes at 80° C. The film was then—together with the glass plate—placed into a water bath having room temperature for 1 hour. Then, a film was removed manually and dried over a period of 24 hours under vacuum at 80° C. Inventive polymer layer (e.g., separator) (D.6) was so obtained.

Polymer layers (Separators) (D.7) to (D.13) could be made accordingly. Details are summarized in Table 1.

TABLE 1
Manufacture of polymer layers (e.g., separators).

| | | Solid content | Amount | |
|---|---|---|---|---|
| | Polymer | reaction | reaction | Amount |
| Reaction | Layer | product | product | (α.1) |
| product | (Separator) | [wt %] | [g] | [g] |
| RP.6 | D.6 | 30.0 | 20.0 | 2.58 |
| RP.7 | D.7 | 18.0 | 33.5 | 2.95 |
| RP.8 | D.8 | 19.3 | 31.3 | 2.99 |
| RP.9 | D.9 | 30.0 | 20.0 | 2.30 |
| RP.11 | D.11 | 15.6 | 38.5 | 0.13 |
| RP.13 | D.13 | 30.0 | 20.0 | 1.57 |
| RP.14 | D.14 | 30.0 | 20.0 | 2.30 |

The specific ionic conductivities of polymer layers (e.g., separators) (D.6) to (D.14) were determined in 8 wt % lithium his trifluoromethanesulfonimide (LiTFSI), 4 wt % LiNO₂ in a 1:1 (by weight) mixture of 1,2-dimethoxyethane/1,3-dioxolane. The results are summarized in Table 2.

TABLE 2
Specific Ionic Conductivities of polymer layers (e.g., separators)

| Polymer Layer | | Specific ionic |
|---|---|---|
| (Separator) | Thickness [μm] | conductivity [mS/cm] |
| (D.6) | 15 | 0.135 |
| (D.7) | 26 | 0.220 |
| (D.8) | 62 | 0.665 |
| (D.9) | 107 | 0.385 |
| (D.11) | 85 | 0.300 |
| (D.13) | 47 | 0.130 |
| (D.14) | 116 | 0.820 |

### III. Test of Polymer Layers (e.g., Separators) for Polysulfide Stability

Polyimide films samples (0.1˜0.15 g) were placed in 50 ml sample vials and 8 g of polysulfide solution (0.5 mol Li₂S₆) in 1,2-dimethoxyethane were added and the sealed sample vials were heated at 70° C. for 72 hours. The polyimide films were removed and washed with 1,2-dimethoxyethane for 24 hours at 70° C. After rinsing with 1,2-dimethoxyethane the polymer films were dried at 80° C. under vacuum for 72 hours. The structural integrity of the film was judged by visual inspection Table 3 summarizes the results.

TABLE 3
Polysulfide stability of polymer layers (e.g., separators)

| Polymer Layer | | |
|---|---|---|
| (Separator) | Thickness [μm] | visual inspection |
| (D.6) | 15 | stable |
| (D.7) | 26 | stable |
| (D.8) | 62 | stable |

### IV. Thermal Characterization of Polymer Layers (Separators) D6, D7 and D13

Three polymer layers (e.g., separators), D6, D7, and D13, were used as an example to examine their thermal behaviors with DSC and TGA. All three membranes were uniform, continuous, and flexible with a thickness in the range of 20 to 25 mm. These free standing films were used for thermal characterization. All three polymer layers (e.g., separators) did not show a glass transition temperature (T_{g}) (see Table 4). Therefore, there was little or no softening of the polymer layers/separators until the temperature hit the decomposition temperature. TGA analysis of the polymer layers/separators reveal onset for decomposition temperature (T_{d}) of about 370° C. for all three polymer layers/separators.

TABLE 4
DSC and TGA data of the three polymer layers/separators

| | |
|---|---|
| Polymer Layers | TGA |

| (Separators) | DSC | Wt loss, <2% | T_{d} |
|---|---|---|---|
| D6 | No Tg | 250° C. | 370° C. |
| D7 | No Tg | 250° C. | 370° C. |
| D13 | No Tg | 250° C. | 370° C. |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of t and an he present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A lithium-sulfur electrochemical cell, comprising:
an anode comprising lithium metal or a lithium metal alloy;
a polymer layer comprising a polymeric material, wherein the polymeric material comprises a branched polyimide formed by reaction of:
(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof; and
(b) at least one diol or triol; and
a cathode comprising sulfur.

2. A lithium-sulfur electrochemical cell, comprising:
an anode comprising lithium metal or a lithium metal alloy;
a polymer layer comprising a polymeric material, wherein the polymer material has a decomposition temperature of greater than or equal to about 200° C.; and
a cathode comprising sulfur,
wherein the electrochemical cell is adapted and arranged to operate at a temperature of greater than or equal to about 150° C. without employing an auxiliary cooling mechanism and without the electrochemical cell experiencing thermal runaway.

3. The electrochemical cell of claim 1, wherein the polymer layer is formed from at least one reaction product of:
(a) at least one polyimide selected from condensation products of:
(α) at least one polyisocyanate having on average at least two isocyanate groups per molecule; and
(β) at least one polycarboxylic acid having at least 3 COOH groups per molecule or an anhydride or ester thereof, and
(b) at least one diol or triol,
said reaction product being subsequently reacted with
(c) at least one polyisocyanate having on average at least two isocyanate groups per molecule.

4. The electrochemical cell of claim 1, wherein the at least one polyisocyanate (α) has on average at least 2.5 isocyanate groups per molecule.

5. The electrochemical cell of claim 1, wherein the at least one polycarboxylic acid (β) has on average 4 COOH groups per molecule or an anhydride or ester thereof.

6. The electrochemical cell of claim 1, wherein the at least one polycarboxylic acid (β) comprises an anhydride group.

7. The electrochemical cell of claim 3, wherein the at least one polyisocyanate (c) has on average 2 isocyanate groups per molecule.

8. The electrochemical cell of claim 3, wherein the at least one polyisocyanate (c) has on average at least 2.2 isocyanate groups per molecule.

9. The electrochemical cell of claim 3, wherein the at least one polyisocyanate (c) has on average between at least 2 and up to about 6 isocyanate groups per molecule.

10. The electrochemical cell of claim 1, wherein the polymer layer is incorporated into a separator positioned between the anode and the cathode.

11. The electrochemical cell of claim 1, wherein polyisocyanate (α) is selected from oligomeric hexamethylene diisocyanate, oligomeric tetramethylene diisocyanate, oligomeric isophorone diisocyanate, oligomeric diphenylmethane diisocyanate, oligomeric toluylene diisocyanate and mixtures of the above mentioned polyisocyanates.

12. The electrochemical cell of claim 1, wherein polymer layer has a thickness in the range of from about 1 to about 20 μm.

13. The electrochemical cell of claim 1, wherein the polymer layer has a thickness in the range of from about 1 to about 10 μm.

14. The electrochemical cell of claim 1, wherein the polymer layer has a thickness about 1 μm.

15. The electrochemical cell of claim 1, wherein polyimide (a) has a polydispersity M_{w}/Mₙ of at least 1.4.

16. The electrochemical cell of claim 1, wherein the polyimide (a) has a polydispersity M_{w}/Mₙ of between about 2 and about 4.

17. The electrochemical cell of claim 1, wherein the polymer layer is directly adjacent the anode.

18. The electrochemical cell of claim 1, wherein the polymer layer is directly adjacent the cathode.

19. The electrochemical cell of claim 1, wherein the polymer layer functions as a protective layer for the cathode.

20. The electrochemical cell of claim 1, wherein the polymer layer functions as a protective layer for the anode.

21. The electrochemical cell of claim 1, wherein the cathode includes elemental sulfur as a cathode active species.

22. The electrochemical cell of claim 1, wherein the polymer layer comprises at least one lithium salt.

23. The electrochemical cell of claim 22, wherein the lithium salt is selected from LiNO₃, LiPF₆, LiBF₄, LiClO₄, LiAsF₆, Li₂SiF₆, LiSbF₆, LiAlCl₄, lithium bis-oxalatoborate, LiCF₃SO₃, LiN(SO₂F)₂, LiC(CₙF₂ₙ₊₁SO₂)₃, wherein n is an integer in the range of from 1 to 20, and salts of the general formula (CₙF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicon.

24. The electrochemical cell of claim 1, wherein the ionic conductivity of the polymer layer is at least about 1×10⁻⁴ S/cm at room temperature in a swollen state.

25. The electrochemical cell of claim 1, wherein the polymer layer is stable to an applied pressure of at least 10 kg/cm² in a swollen state.

26. The electrochemical cell of claim 1, wherein the polymer layer is a gel polymer layer.

27. The electrochemical cell of claim 1, wherein the electrochemical cell comprises the solvents 1,2-dimethoxyethane and/or 1,3-dioxolane.

28. The electrochemical cell of claim 1, wherein diol (b) is a polyalkyleneoxide.

29. The electrochemical cell of claim 1, wherein diol (b) is polyethylene oxide, polypropylene oxide, polybutylene oxide, or polytetrahydrofuran (poly-THF).

30. The electrochemical cell of claim 1, wherein the branched polyimide has a decomposition temperature of greater than or equal to about 200° C.

31. The electrochemical cell of claim 1, wherein the electrochemical cell is constructed and arranged to operate at a temperature of greater than or equal to about 150° C. without employing an auxiliary cooling mechanism and without the electrochemical cell experiencing thermal runaway.
